(19) United States
(12) Patent Application Publication
(10) Pub. No.: US 2026/0277834 A1
(43) Pub. Date: Sep. 17, 2026

(54) INTEGRATED CIRCUIT INCLUDING DIRECT MEMORY ACCESS CIRCUIT FOR DISTRIBUTED OPERATION AND ELECTRONIC DEVICE INCLUDING SAME

(71) Applicant: Samsung Electronics Co., Ltd., Suwon-si (KR)

(72) Inventors: Hyunbin PARK, Suwon-si (KR); Junhyuk LEE, Suwon-si (KR)

(21) Appl. No.: 19/665,366

(22) Filed: May 1, 2026

Related U.S. Application Data
(63) Continuation of application No. PCT/KR2024/015808, filed on Oct. 17, 2024.

(30) Foreign Application Priority Data
Nov. 3, 2023 (KR) 10-2023-0151251
Dec. 22, 2023 (KR) 10-2023-0190481

(51) Int. Cl. G06F 13/28

(52) U.S. Cl. CPC G06F 13/28; G06F 2213/28

(57) ABSTRACT

An electronic device is provided. The electronic device includes volatile memory and at least one processor communicatively coupled to the volatile memory, wherein the at least one processor includes a first die including a neural processing unit (NPU) circuit, a second die including cache memory and direct memory access (DMA) controller for data communication between the cache memory and the volatile memory, and a bus interface including through silicon vias (TSVs) provided between the first die and the second die. The at least one DMA processor configured to perform an operation on a portion of data related to a neural network, and transmit the remaining portion to the NPU circuit of the first die through the bus interface in order to perform an operation of the NPU circuit for the remaining portion of the data different from the portion.

### CROSS-REFERENCE TO RELATED APPLICATION(S)

This application is a continuation application, claiming priority under 35 U.S.C. § 365(c), of an International application No. PCT/KR2024/015808, filed on Oct. 17, 2024, which is based on and claims the benefit of a Korean patent application number 10-2023-0151251, filed on Nov. 3, 2023, in the Ministry of Intellectual Property (MOIP), and of a Korean patent application number 10-2023-0190481, filed on Dec. 22, 2023, in the Ministry of Intellectual Property (MOIP), the disclosure of each of which is incorporated by reference herein in its entirety.

### BACKGROUND

### 1. Field

The disclosure relates to an integrated circuit (IC) (e.g., an application processor (AP)) including direct memory access (DMA) circuitry for a distributed computation and an electronic device including the same.

### 2 Description of Related Art

A system on a chip (SOC) is an electronic component in which circuitry performing different functions are integrated. In a case that the number of functions supported by an electronic device including the SOC is increased, complexity of the circuitry integrated in the SOC may be increased.

The above-information is presented as background information only to assist with an understanding of the disclosure. No determination has been made, and no assertion is made, as to whether any of the above might be applicable as a prior art with regard to the disclosure.

### SUMMARY

Aspects of the disclosure are to address at least the above-mentioned problems and/or disadvantages and to provide at least the advantages described below. Accordingly, an aspect of the disclosure is to provide an integrated circuit including direct memory access (DMA) circuitry for a distributed computation and an electronic device including the same.

Additional aspects will be set forth in part in the description which follows and, in part, will be apparent from the description, or may be learned by practice of the presented embodiments.

In accordance with an aspect of the disclosure, a mobile communication device is provided. The mobile communication device includes processing circuitry, memory, including one or more storage media, storing instructions, and at least one direct memory access (DMA) processor positioned outside the processing circuitry communicatively coupled to the processing circuitry and the memory, wherein the at least one DMA processor may be configured to, when controlled by the processing circuitry, perform a first computation, among first data and second data, with respect to the first data, transmit a result of the first computation to the processing circuitry or the memory, wherein the processing circuitry is configured to perform a second computation with respect to the result of the first computation or the second data, and transmit a result of the second computation to the memory.

In accordance with another aspect of the disclosure, an electronic device provided. The electronic device includes volatile memory, including one or more storage media, storing instructions, and at least one processor communicatively coupled to the volatile memory, the processor includes a first die including a neural processing unit (NPU), a second die including cache memory and direct memory access (DMA) controller for data communication between the volatile memory and the cache memory, and a bus interface including through silicon vias (TSVs) disposed between the first die and the second die, wherein the at least one DMA processor may be configured to, based on identifying a command associated with computation of data associated with a neural network from the NPU circuitry, store, in the cache memory, the data stored in the volatile memory, perform the computation with respect to a portion of the data that is stored in the cache memory, and transmit, to perform computation of the NPU circuitry with respect to a remaining portion of the data different from the portion, the remaining portion to the NPU circuitry in the first die through the bus interface.

In accordance to another aspect of the disclosure, a method of direct memory access (DMA) processor for data communication between volatile memory, including one or more storage media, storing instructions, and cache memory in a processor is provided. The method includes, based on identifying a command associated with computation of data associated with a neural network from neural processing unit (NPU) circuitry disposed on a first die of the processor, storing, in the cache memory, the data stored in the volatile memory, wherein the DMA processor is disposed on a second die different from the first die, performing the computation with respect to a portion of the data that is stored in the cache memory, and transmitting, to perform computation of the NPU circuitry with respect to a remaining portion of the data different from the portion, the remaining portion to the NPU circuitry in the first die through a bus interface including through silicon vias (TSVs) disposed between the first die and the second die.

In accordance with another aspect of the disclosure, a processing chip component is provided The processing chip component includes a port for data communication with volatile memory, including one or more storage media, storing instructions, at least one DMA processor communicatively coupled to the port, and a plurality of data processing circuitry configured to control the at least one DMA processor, wherein the at least one DMA processor is configured to identify a command to perform computation of a first matrix and a second matrix by using the data communication by using the at least one DMA processor, from any one of data processing circuitry among the plurality of data processing circuitry, obtain the first matrix and the second matrix from the volatile memory through the port based on the command, in response to obtaining the first matrix smaller than or equal to a size of a buffer included in the at least one DMA controller from the volatile memory, perform the computation of the first matrix and the second matrix indicated by the command before transmitting the first matrix and the second matrix to the data processing circuitry corresponding to the command, based on obtaining the first matrix exceeding the size of the buffer from the volatile memory, perform computation with respect to a first portion of the first matrix and a second portion of the second matrix, and transmit a remaining portion of the first matrix different from the first portion and a remaining portion of the second matrix different from the second portion to the data processing circuitry corresponding to the command.

In accordance with aspect of the disclosure, a method of a processing chip component including a port for data communication with volatile memory, including one or more storage media, storing instructions, at least one direct memory access (DMA) processor connected to the port, and a plurality of data processing circuitry configured to control the at least one DMA processor are provided. The method includes identifying a command to perform computation of a first matrix and a second matrix by using the data communication by using the at least one DMA processor, from any one of data processing circuitry among the plurality of data processing circuitry, obtaining the first matrix and the second matrix from the volatile memory through the port based on the command, obtaining the first matrix smaller than or equal to a size of a buffer included in the at least one DMA processor from the volatile memory, performing the computation of the first matrix and the second matrix indicated by the command before transmitting the first matrix and the second matrix to the data processing circuitry corresponding to the command, based on obtaining the first matrix exceeding the size of the buffer from the volatile memory, performing computation with respect to a first portion of the first matrix and a second portion of the second matrix, and transmitting a remaining portion of the first matrix different from the first portion and a remaining portion of the second matrix different from the second portion to the data processing circuitry corresponding to the command.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which”

FIGS. 1A and 1B illustrate a hardware configuration of an electronic device including a direct memory access controller according to various embodiments of the disclosure;

FIG. 2 illustrates a block diagram of a direct memory access (DMA) controller according to an embodiment of the disclosure;

FIG. 3 illustrates a flowchart of a DMA controller included in an electronic device according to an embodiment of the disclosure

FIG. 4 illustrates an operation of a DMA controller that transmits data, such as a matrix according to an embodiment of the disclosure;

FIGS. 5A, 5B, and 5C illustrate operations of a DMA controller that performs computation of matrices according to various embodiments of the disclosure;

FIG. 6 illustrates an operation of a DMA controller that performs element-wise computation according to an embodiment of the disclosure;

FIG. 7 illustrates an operation of an electronic device for controlling a DMA controller based on execution of a software application according to an embodiment of the disclosure;

FIG. 8 illustrates a flowchart of a DMA controller included in an electronic device according to an embodiment of the disclosure;

FIG. 9 illustrates a flowchart of a DMA controller included in an electronic device according to an embodiment of the disclosure; and

FIG. 10 is a block diagram of an electronic device in a network environment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

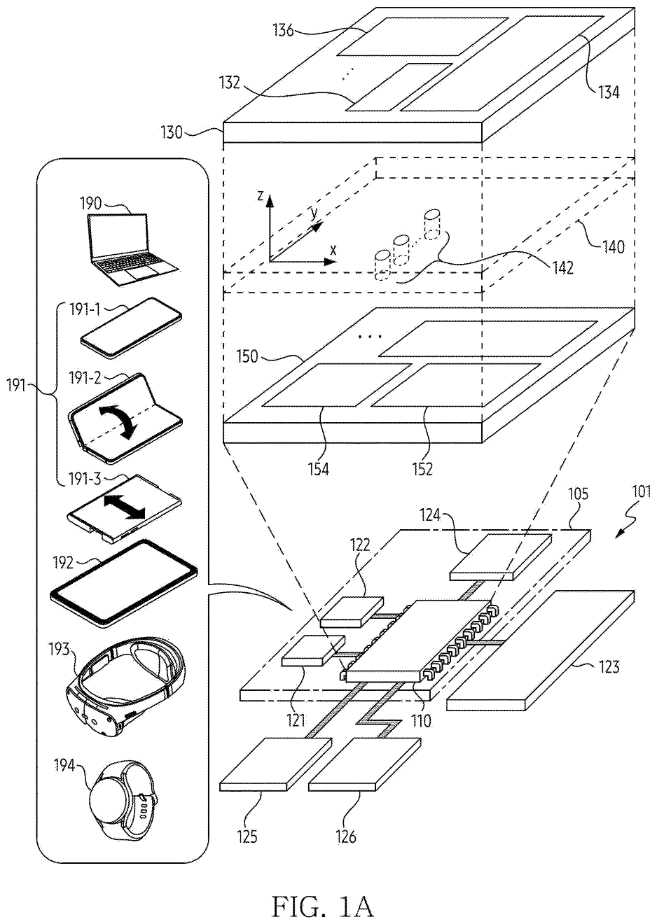

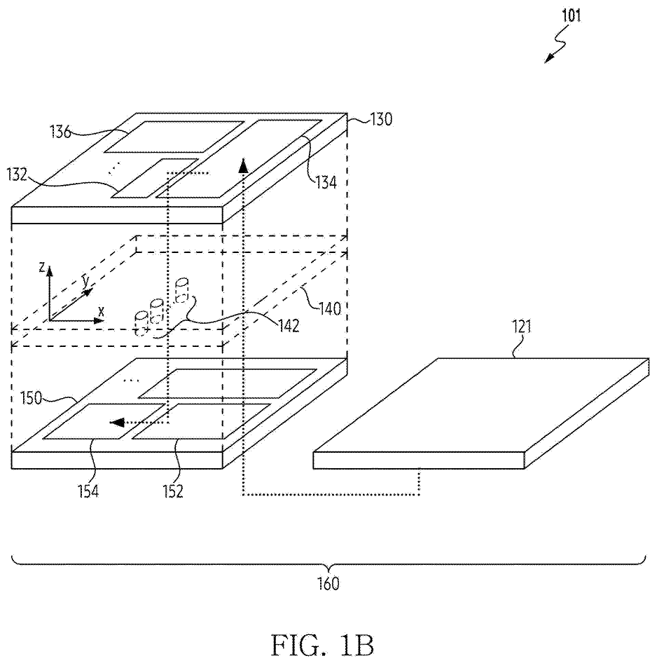

FIGS. 1A and 1B illustrate a hardware configuration of an electronic device including a direct memory access controller according to various embodiments of the disclosure.

Referring to FIG. 1A, an electronic device 101 may be one of various forms of electronic devices, such as a laptop personal computer (PC) 190, smartphones 191 with various form factors (e.g., a bar-type smartphone 191-1, a foldable-type smartphone 191-2, or a slidable (or rollable)-type smartphone 191-3), a tablet PC 192, a head-mounted display (HMD) device 193, a watch 194, a cellular phone (not illustrated), and other similar computing devices (not illustrated). The electronic device 101 may be referred to as a mobile device, a user equipment (UE) (or a user terminal), a multifunctional device, a portable communication device, a portable device, or a server. A form factor of the electronic device 101 is not limited to the form factors illustrated in FIG. 1A. For example, the electronic device 101 may be included as an electronic control unit (ECU) in a vehicle (e.g., an electric vehicle (EV)). For example, the electronic device 101 may have a form factor wearable by a user, such as an earbud (or a wireless earphone) and/or a ring, or may have a form factor implantable in a part of a body of the user.

The components illustrated in FIG. 1A, their relationships, and their functions are merely examples and do not limit the implementations described or claimed in the disclosure. Referring to FIG. 1A, the electronic device 101 according to an embodiment may include components, such as a processor (e.g., an application processor (AP), a communication processor (CP), or any combination thereof) 110, memory (e.g., volatile memory 121, and/or non-volatile memory 122), a display 123, communication circuitry 124, an image sensor 125, and/or a sensor 126. For example, the processor may be implemented as a three-dimension integrated circuit (3D-IC) including a plurality of circuitry layer.

Referring to FIG. 1A, an embodiment in which the processor 110, the volatile memory 121, the non-volatile memory 122, and/or the communication circuitry 124 are disposed on (or over) a printed circuit board (PCB) 105 is illustrated, but the embodiment is not limited thereto. On the PCB 105, the processor 110 may be electronically and/or operably coupled with the volatile memory 121, the non-volatile memory 122, and/or the communication circuitry 124. The PCB 105 on which the processor 110 is disposed may be referred to as a main board and/or a motherboard. Hereinafter, the components being operably coupled with each other may mean that a direct connection or an indirect connection between the components is established by wire or wirelessly such that a second component is controlled by a first component among the components.

The components included in the electronic device 101 are not limited to an embodiment of FIG. 1A, and the electronic device 101 may include other components (e.g., a power management integrated circuit (PMIC), audio processing circuitry, a speaker, a microphone, an antenna, a rechargeable battery, or an input-output interface). A position of each of the components electronically and/or operably coupled with the processor 110 is not limited to the position on the PCB 105, and may have a position at least partially exposed to the outside through a housing of the electronic device 101. For example, some components may be omitted from the electronic device 101. For example, several components may be integrated into one component.

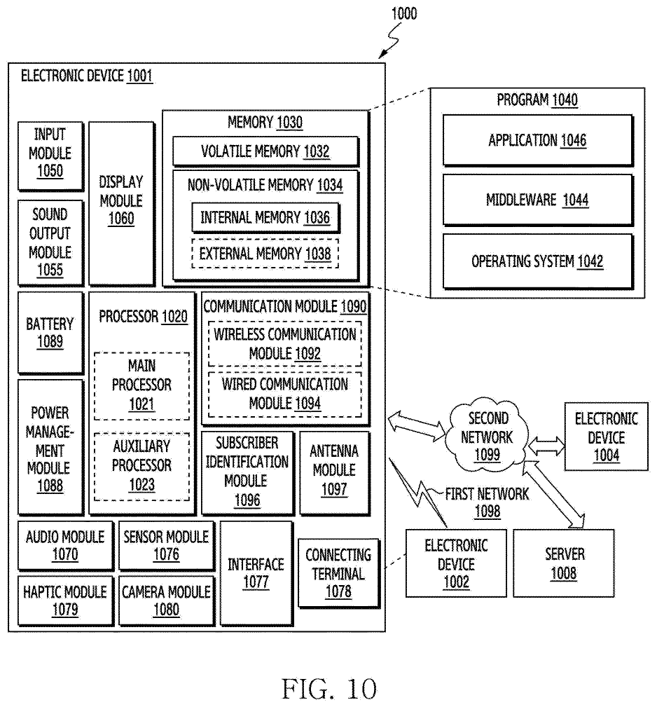

Referring to FIG. 1A, the volatile memory 121 and/or the non-volatile memory 122 may be configured to store data and/or instructions based on an address map managed by the processor 110. The display 123 may display an image and/or a video provided from the processor 110 on a surface (e.g., a flat surface and/or a curved surface) of the housing of the electronic device 101. The communication circuitry 124 may be configured to support wired communication and/or wireless communication between the electronic device 101 including the processor 110 and an external electronic device. The image sensor 125 may be configured to provide an electrical signal representing external light to the processor 110 and/or the memory (e.g., the volatile memory 121 and/or the non-volatile memory 122). The sensor 126 may be configured to provide an electrical signal based at least on an external environment to the processor 110 and/or the memory (e.g., the volatile memory 121 and/or the non-volatile memory 122). Each of the volatile memory 121, the non-volatile memory 122, the display 123, the communication circuitry 124, the image sensor 125, and the sensor 126 of FIG. 1A may correspond to volatile memory 1032, non-volatile memory 1034, a display module 1060, a communication module 1090, a camera module 1080, and a sensor module 1076 illustrated in FIG. 10.

The electronic device 101 according to an embodiment may include the processor 110 for processing data. The processor 110 may include a circuit element including a passive element, a transistor, a diode, or a combination thereof. In the processor 110, logic circuitry for processing data may be interconnected with each other. The processor 110 may be referred to as an integrated circuit (IC) and/or a system on chip (SoC). The circuitry included in the processor 110 may be divided into a unit, a module, and/or an electronic component according to a function. For example, the processor 110 may include electronic components, such as central processing unit (CPU) circuitry 136, graphics processing unit (GPU) circuitry, neural processing unit (NPU) circuitry 154, an image signal processor (ISP), a serial communication interface (SCI), a signal interface (I/F), a high speed synchronous serial interface (HSI), memory management (M/M), low power dynamic random access memory (LP-DDR) physical interface (PHY) 320, a display controller, memory controller, a storage controller, an application processor (AP), a communication processor (CP), and/or a sensor interface. Hereinafter, a unit, a module, and/or an electronic component may be a set of circuitry included in the processor 110, and may mean at least a portion of the processor 110 designed to execute a specific function. The processor 110 of FIG. 1A may correspond to a processor 1020 of FIG. 10.

The processor 110 according to an embodiment may have a three-dimension integrated circuit (3D-IC) structure in which a plurality of dies are stacked. In terms of including one or more circuit elements, a die may be referred to as a circuit layer, a semiconductor layer, and/or an integrated circuit (IC) layer. A yield of a die (e.g., a defect rate of the die) may decrease as an extent of the die reduces (e.g., a random fail). Since the processor 110 designed to include a plurality of dies includes dies having an extent smaller than a case designed to include a single die, it may be produced with a yield increased than the case. Hereinafter, a “layer” may be used as a term for distinguishing dies and/or substrates stacked along a reference direction (a direction of a z-axis in an embodiment of FIG. 1A) in the processor 110. For example, the “layer” may be replaced with terms, such as a “substrate”, a “layer”, a “semiconductor die”, and/or a “die”. The processor 110 may include a plurality of dies based on a silicon wafer. An embodiment is not limited thereto, and a die based on a silicon carbide (SiC) wafer, a gallium nitride (GaN) wafer, and/or a gallium arsenide (GaAs) wafer may be included in the processor 110.

The processor 110 according to an embodiment may include a first die 130 and a second die 150. The first die 130 may be disposed (or positioned) above the second die 150 in the processor 110. Referring to FIGS. 1A and/or 1B, a structure of the second die 150 included in the processor 110 and the first die 130 disposed over the second die 150 along a z-axis direction (e.g., a vertical direction) is illustrated. The first die 130 and the second die 150 may be arranged parallel to an x-y plane in the processor 110. Based on the first die 130 and/or the second die 150 disposed along the z-axis direction, circuit elements may have distinct three-dimensional locations in the processor 110. In terms of including the circuit elements having three-dimensional locations, the processor 110 may be referred to as a three-dimension integrated circuit (3D-IC), 3D packaging, 3D stacked ICs (SICs), processing circuitry, a processing chip component, and a monolithic 3D IC.

The processor 110 according to an embodiment may include at least one interconnect layer (or connection layer) 140 disposed between the first die 130 and the second die 150. The interconnect layer may be referred to as an interposer layer (or an interposer). The interconnect layer may be formed based on a material, such as silicon, glass, and/or an organic compound.

In an embodiment of the disclosure, the processor 110 may further include not only the first die 130, the second die 150, and the interconnect layer 140 illustrated in FIG. 1A, but also another component not illustrated in FIG. 1A. For example, the processor 110 may include a substrate, a redistribution layer (RDL), and/or at least one solder ball. The substrate and/or the RDL may be disposed under the second die 150 along a −z-axis direction, for example. The processor 110 may include a packaging structure covering the above-described component.

In an embodiment of the disclosure, the interconnect layer 140 formed between the first die 130 and the second die 150 may include a component for supporting an electrical connection between the first die 130 and the second die 150. The component may include a through silicon via (TSV). The TSV may be referred to as a through chip via and/or a through hole. The component is not limited to the TSV, and may include another component (e.g., a bonding wire) for an electrical connection in the z-axis direction. The interconnect layer 140 may be formed in various forms. For example, the interconnect layer 140 may be formed with substantially the same width, height, thickness, extent, shape, and/or size as the first die 130 and/or the second die 150, but is not limited thereto, and may be formed with various widths, heights, thicknesses, extents, shapes, and/or sizes. According to an embodiment of the disclosure, the interconnect layer 140 may include at least one connection member (e.g., a wire, a solder bump, a metal bump, or another conductive adhesive) based on a connection technology different from the TSV. The first die 130 and the second die 150 may be electrically connected through the connection member included in the interconnect layer 140.

Referring to FIG. 1A, the processor 110 may include a bus interface including a plurality of TSVs 142 formed in the interconnect layer 140. The bus interface, which includes the plurality of TSVs 142 disposed between the first die 130 and the second die 150, may be configured to support communication between circuitry included in the first die 130 and circuitry included in the second die 150 (e.g., communication of a data signal and/or a control signal). According to an embodiment of the disclosure, the electronic device 101 and/or the processor 110 may include a DMA controller 132 designed to reduce a bandwidth of the bus interface including the plurality of TSVs 142. In order to reduce the bandwidth of the bus interface and/or occupancy of the DMA controller 132, the DMA controller 132 may include computation circuitry.

In an embodiment of the disclosure, the DMA controller 132 may be disposed in the processor 110 to prevent data processing circuitry, such as the CPU circuitry 136, the GPU circuitry, and/or the NPU circuitry 154 from directly transmitting data (e.g., large amounts of image, video, file, and/or matrix) between the data processing circuitry and the memory (e.g., cache memory 134 and/or the volatile memory 121). While the data processing circuitry directly transmits the data, the data processing circuitry may not perform another computation associated with a software application and/or a user input. The DMA controller 132 may enable the data processing circuitry to execute the software application more rapidly or respond more rapidly to the user input by transmitting the data according to a command of the data processing circuitry.

In an embodiment of the disclosure, within the processor 110 including various data processing circuitry, such as the CPU circuitry 136, the GPU circuitry, and/or the NPU circuitry 154, the DMA controller 132 configured to support caching, loading, and/or output of data generated from different data processing circuitry may be included. In terms of being controllable by a plurality of data processing circuitry (e.g., the CPU circuitry 136, the GPU circuitry, and/or the NPU circuitry 154), the DMA controller 132 may be referred to as a central DMA controller. Referring to FIG. 1A, the DMA controller 132 may be included in the first die 130 of the processor 110. The DMA controller 132 may perform an operation associated with data communication between the cache memory 134 and the volatile memory 121. Referring to FIG. 1A, an embodiment in which both the DMA controller 132 and the cache memory 134 are included in the first die 130 is illustrated, but the embodiment is not limited thereto.

In an embodiment of the disclosure, the cache memory 134 may be referred to as a last-level cache (LLC). The cache memory 134 included in the processor 110 may store data used by the data processing circuitry (e.g., the CPU circuitry 136, the GPU circuitry, and/or the NPU circuitry 154) included in the processor 110. Hereinafter, the caching may mean an operation in which data is moved from the non-volatile memory 122 and/or the volatile memory 121 to the cache memory 134. The DMA controller 132 may be configured to control data communication generated between the cache memory 134, the volatile memory 122, and/or the non-volatile memory 122, such as the caching.

Referring to FIG. 1A, the processor 110 may include the CPU circuitry 136 as data processing circuitry. The CPU circuitry 136 may be configured to perform computation indicated by a binary code referred to as an instruction. The instruction may be stored in the cache memory 134, the volatile memory 122, and/or the non-volatile memory 122. The CPU circuitry 136 may execute a function supported by a software application including the instructions by sequentially performing computations indicated by the instructions stored in the cache memory 134.

Referring to FIG. 1A, the processor 110 may include the NPU circuitry 154 as data processing circuitry. The NPU circuitry 154 may be configured to perform computation associated with a neural network. The neural network is a recognition model implemented with software or hardware that mimics a computational capability of a biological system using a plurality of artificial neurons (or perceptrons and/or nodes). Using the neural network, the electronic device 101 including the processor 110 may simulate a human cognitive action and/or a learning process. Parameters associated with the neural network may indicate weights assigned to a plurality of nodes and/or a connection between the plurality of nodes. Instructions indicating the weights and/or one or more computations for simulating a neural network based on the weights may be stored in the electronic device 101 in a form of a software application and/or a system process and/or a library for executing the software application.

Although an embodiment of the processor 110 and/or the electronic device 101 including the CPU circuitry 136 and the NPU circuitry 154 is illustrated, the embodiment is not limited thereto. For example, the processor 110 may include the GPU circuitry configured to perform computation associated with graphic rendering. For example, the processor 110 may include image signal processor (ISP) circuitry configured to perform computation associated with an image and/or a video obtained from a camera. The GPU circuitry and the ISP circuitry may also generate or transmit a signal for controlling the DMA controller 132 as data processing circuitry.

Referring to FIG. 1A, the DMA controller 132, the cache memory 134, and the CPU circuitry 136 may be disposed on the first die 130 of the processor 110. Network on chip (NOC) circuitry 152 and the NPU circuitry 154 may be disposed on the second die 150 of the processor 110. Such as the NPU circuitry 154, data processing circuitry disposed in a die (e.g., the second die 150) different from the DMA controller 132 may transmit a control signal to the DMA controller 132 through the bus interface including the plurality of TSVs 142.

The DMA controller 132 that has received the control signal for transmitting data to the NPU circuitry 154 may transmit the data stored (or cached) in the cache memory 134 to the NPU circuitry 154. In a case that data corresponding to the control signal is not in the cache memory 134, a cache miss may occur. In response to the cache miss, the DMA controller 132 may copy, move, or store the data stored in memory (e.g., the volatile memory 121 and/or the non-volatile memory 122) different from the cache memory 134, to the cache memory 134. While the data corresponding to the control signal is moved from the DMA controller 132 to the NPU circuitry 154 through the bus interface, at least one of the plurality of TSVs 142 may be used for transmission of the data.

Transmission of a signal using the plurality of TSVs 142 may require relatively more power than transmission of a signal in a die, such as the first die 130 and/or the second die 150. In an embodiment of the disclosure, in a case that data processing circuitry (e.g., the NPU circuitry 154 in the second die 150) disposed on a die different from the DMA controller 132 controls the DMA controller 132 to perform computation, the DMA controller 132 may be configured to at least partially transmit the computation. Since the DMA controller 132 at least partially transmits the computation, a size of data to be transmitted using the plurality of TSVs 142 and inputted to the data processing circuitry for the computation may be reduced. Since the size of the data transmitted using the plurality of TSVs 142 is reduced, power consumed by the processor 110 may decrease.

Referring to FIG. 1B, an chipset 160 including all of the first die 130, the interconnect layer 140, the second die 150, and the volatile memory 121 is illustrated. The first die 130, the interconnect layer 140, and the second die 150 of FIG. 1A may be packaged in the chipset 160. The chipset 160 may be referred to as a system on a chip (SOC) and/or an application processor (AP). In the chipset 160, the second die 150 and the volatile memory 121 may be disposed on the RDL. Data stored in the volatile memory 121 may be moved up to the second die 150 through the RDL. The data moved up to the second die 150 may be transmitted to the cache memory 134 through another TSV in the interconnect layer 140 different from the plurality of TSVs 142 included in the bus interface. Similarly, data stored in the cache memory 134 may be moved up to the volatile memory 121 through the RDL.

Referring to FIG. 1B, in order to transmit data to the NPU circuitry 154, the DMA controller 132 may cache the data. For example, for the caching, data stored in the volatile memory 121 may be transmitted to the cache memory 134 through the RDL of the chipset 160. The DMA controller 132 may transmit the data stored in the cache memory 134 to the NOC circuitry 152 on the second die 150 through the bus interface including the plurality of TSVs 142. The NOC circuitry 152 may transmit the data received through the bus interface to the NPU circuitry 154. The NOC circuitry 152 may be configured to control transmission and/or reception of a signal between circuitry and/or electronic components disposed in the second die 150 on which the NOC circuitry 152 is disposed. The NPU circuitry 154 may store a result of performing computation based on the data in the DMA controller 132 and/or the cache memory 134 through the bus interface.

Referring to FIG. 1B, in an embodiment in which the DMA controller 132 at least partially performs computation of the NPU circuitry 154, a first size of data moved to the cache memory 134 through the RDL and a second size of data moved from the DMA controller 132 to the NPU circuitry 154 and/or the NOC circuitry 152 through the bus interface including the plurality of TSVs 142 for the computation may be different. For example, the second size may be smaller than the first size. Since the second size of data transmitted from the DMA controller 132 to the NPU circuitry 154 through the plurality of TSVs 142 is smaller than the first size, power consumed to transmit data using the plurality of TSVs 142 may decrease compared to a case of transmitting all data of the first size.

In an embodiment of the disclosure, the first die 130 on which the DMA controller 132 is disposed and the second die 150 on which data processing circuitry, such as the NPU circuitry 154 is disposed may be produced based on different processes. For example, the first die 130 may be produced based on a first process with a minimum line width (or line pitch) of 3 nm. For example, the second die 150 may be produced based on a second process with a minimum line width of a length (e.g., 4 nm and/or 5 nm) larger than 3 nm. In the example, a minimum size of circuit elements included in the first die 130 may be larger than a minimum size of circuit elements included in the second die 150. In an embodiment in which the first die 130 including the DMA controller 132 is produced based on a process with a smaller minimum line width than the second die 150 including the NPU circuitry 154, due to characteristics of the process, the DMA controller 132 of the first die 130 may operate with less power consumption than the NPU circuitry 154. In the above-described embodiment of the disclosure, in a case that the DMA controller 132 at least partially performs computation performed by the NPU circuitry 154, power consumed to perform the computation may be reduced compared to a case that the NPU circuitry 154 performs the computation as a whole. Due to characteristics of the process, computation performed using the first die 130 and the DMA controller 132 produced in a process with a relatively small minimum line width may be performed faster than computation performed using the second die 150 and the NPU circuitry 154 produced in a process with a relatively large minimum line width.

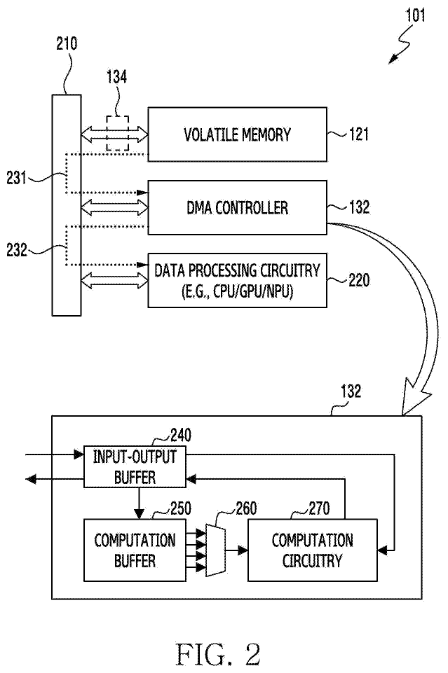

Hereinafter, a structure of circuitry connected to each other through the bus interface is described with reference to FIG. 2.

FIG. 2 illustrates a block diagram of a DMA controller 132 according to an embodiment of the disclosure.

An electronic device 101 of FIG. 2 may be an example of the electronic device 101 of FIGS. 1A and/or 1B.

Referring to FIG. 2, volatile memory 121, cache memory 134, a DMA controller 132, and data processing circuitry 220, which are electrically connected through a bus interface 210, are illustrated. As described above with reference to FIGS. 1A and/or 1B, circuitry connected through the bus interface 210 illustrated in FIG. 2 may be disposed on different dies and/or ICs. An embodiment is not limited thereto, and the circuitry connected through the bus interface 210 illustrated in FIG. 2 may be integrated in one die and/or IC.

According to an embodiment of the disclosure, the data processing circuitry 220 may include at least one of CPU circuitry (e.g., the CPU circuitry 136 of FIGS. 1A and/or 1B), GPU circuitry, and/or NPU circuitry (e.g., the NPU circuitry 154 of FIGS. 1A and/or 1B). The data processing circuitry 220 may include a DMA controller for directly performing movement of data associated with the data processing circuitry 220 independently of the DMA controller 132. The DMA controller included in the data processing circuitry 220 may be referred to as a DMA controller dedicated to data processing circuitry. Data processing circuitry (e.g., a CPU-dedicated DMA) included in the CPU circuitry may be controlled by the CPU circuitry and may not be controlled by other data processing circuitry. On the other hand, the DMA controller 132 may be controlled by a plurality of data processing circuitry as a central DMA controller.

In an embodiment of the disclosure, the data processing circuitry 220 may transmit a control signal indicating computation of data to the DMA controller 132. The control signal may include an address at which data to be used to perform the computation is stored. In a case that the address corresponds to a physical address of the volatile memory 121 mapped to an address map, the DMA controller 132 may move or copy data stored at the address from the volatile memory 121 to the cache memory 134 (caching). The DMA controller 132 may load (or fetch) the data moved to the cache memory 134 through a signal path 231. The data stored in the cache memory 134 may be moved from the cache memory 134 to the DMA controller 132 through the signal path 231 connecting the cache memory 134 and the DMA controller 132 in the bus interface 210. The signal path 231 may physically connect the cache memory 134 and the DMA controller 132 in the bus interface 210. While the data is being transmitted, the data stored in the cache memory 134 may be moved from the cache memory 134 to the DMA controller 132, using at least a portion of the signal path 231 according to an address of the data.

Referring to FIG. 2, the DMA controller 132 may include at least one of an input-output (IO) buffer 240, a computation buffer 250, a computation switch 260, or computation circuitry 270. Data moved by the DMA controller 132 may be at least temporarily stored in the input-output buffer 240. As a non-limiting example, the input-output buffer 240 may be divided into an input buffer for storing data transmitted to the DMA controller 132 and an output buffer for storing data to be transmitted from the DMA controller 132. The input-output buffer 240 may be configured to support data communication based on the DMA controller 132.

In an embodiment of the disclosure, the computation buffer 250, the computation switch 260, and the computation circuitry 270 may be activated or used while the DMA controller 132 at least partially performs computation of the data processing circuitry 220. The computation buffer 250 may be configured to at least temporarily store data to be computed by the DMA controller 132. In an embodiment of the disclosure, the input-output buffer 240 may be referred to as a first buffer of the DMA controller 132, and the computation buffer 250 may be referred to as a second buffer of the DMA controller 132.

In an embodiment of the disclosure, the computation switch 260 may be configured to input at least a portion of data stored in the computation buffer 250 to the computation circuitry 270. The computation circuitry 270 may be connected to the computation buffer 250 through the computation switch 260. An embodiment is not limited thereto, and the computation circuitry 270 may be directly connected to the computation buffer 250. The computation circuitry 270 may be connected to the input-output buffer 240. The computation circuitry 270 may be configured to perform computation of data inputted through the computation switch 260 and/or data stored in the input-output buffer 240. A result of the computation performed by the computation circuitry 270 may be stored in the input-output buffer 240.

In an embodiment of FIG. 2, data moved from the volatile memory 121 and/or the cache memory 134 to the DMA controller 132 through the signal path 231 may be stored in the input-output buffer 240. In a case that a control signal indicates computation of the data based on the DMA controller 132, the DMA controller 132 may perform the computation to input the data stored in the input-output buffer 240 to the computation circuitry 270. In a case that a control signal indicates computation of the data and other data stored in the computation buffer 240, the DMA controller 132 may move the data stored in the input-output buffer 240 to the computation buffer 250 and then store the other data in the input-output buffer 240. The DMA controller 132 may perform the computation indicated by the control signal by inputting, to the computation circuitry 270, the other data stored in the input-output buffer 240 and the data moved to the computation buffer 250.

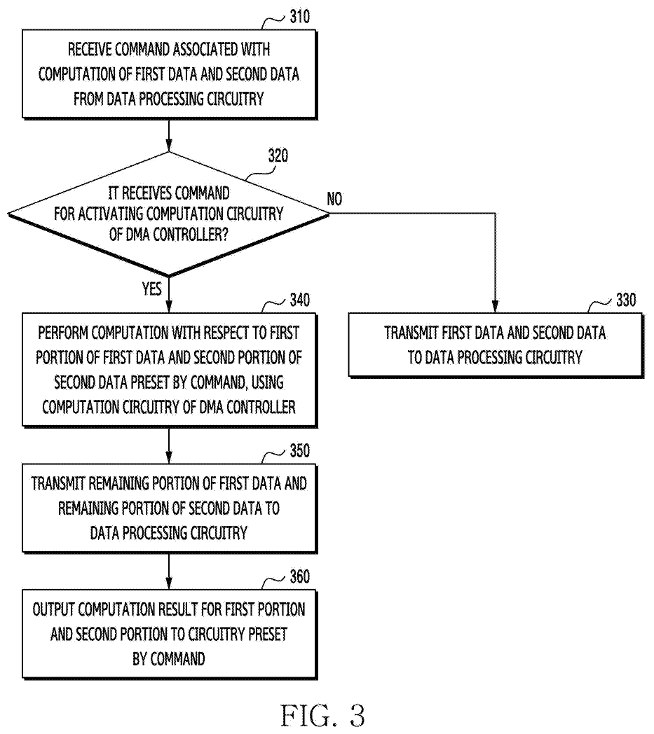

In an embodiment of FIG. 2, in a case that a control signal indicates a load of data by the data processing circuitry 220, the DMA controller 132 may move the data stored in the input-output buffer 240 to the data processing circuitry 220. The data may be moved from the DMA controller 132 to the data processing circuitry 220 through a signal path 232 connecting the DMA controller 132 and the data processing circuitry 220 in the bus interface 210. The data may be moved from the DMA controller 132 to the data processing circuitry 220 through the signal path 232 according to an address of the data. In a case that the data processing circuitry 220 and the DMA controller 132 are disposed on different dies, the signal path 232 may include one or more TSVs (e.g., the plurality of TSVs 142 of FIGS. 1A and/or 1B) electrically connecting the dies. In a case that data is transmitted to data processing circuitry different from the CPU circuitry, such as the NPU circuitry, the DMA controller 132 may transmit a signal (e.g., a software interrupt (SWI) signal) indicating completion of the transmission of the data to the CPU circuitry in response to the completion of the transmission of the data. An operation of the DMA controller 132 associated with a control signal of the data processing circuitry 220 is described with reference to FIG. 3.

In an embodiment receiving a control signal from the data processing circuitry 220, the DMA controller 132 may include a plurality of registers for storing information included in the control signal. The control signal may include an instruction and/or a command for assigning a value (or data) to at least one of the plurality of registers. In an embodiment of the disclosure, the DMA controller 132 may include registers having names of Table 1.

TABLE 1

| | Description of data stored in register having corresponding |
|---|---|
| Name | name |
| SOURCE_ADDR | Address map start address of data to be transferred to the DMA |
| | controller 132 |
| DEST_ADDR | Address in an address map indicating the data processing |
| | circuitry 220 (e.g., the GPU circuitry, the NPU circuitry, and/or |
| | the CPU circuitry) to which data stored in the DMA controller |
| | 132 is to be transmitted |
| DATA_SIZE | Size (e.g., size indicated in units of bytes) of data to be moved |
| | to the DMA controller 132 |
| MODE | Value indicating a mode and/or a state of the DMA controller |
| | 132 |
| WIDTH | In a case that the computation buffer 250 stores a matrix, a |
| | width of the matrix |
| HEIGHT | In a case that the computation buffer 250 stores a matrix, a |
| | height of the matrix |
| DEST_OUT_ADDR | Address in an address map indicating the data processing |
| | circuitry 220 and/or memory (e.g., the cache memory 134 |
| | and/or the volatile memory 121) in which data (e.g., |
| | computation result of the DMA controller 132) outputted from |
| | the computation circuitry 270 of the DMA controller 132 is to |
| | be stored and/or transmitted |

Referring to Table 1, physical addresses of memory cells included in each circuitry of the electronic device 101 may be mapped to an address map. For example, in the address map, an address in a specific range may be mapped to physical addresses of cells stored in the volatile memory 121, and an address in another range different from the specific range may be mapped to a register of the data processing circuitry 220. In the example, the DMA controller 132 may transmit data outputted from the computation circuitry 270 to any one of the data processing circuitry 220, the cache memory 134, or the volatile memory 121 using an address stored in a register having a name of the DEST_OUT_ADDR of Table 1.

Referring to Table 1, the data processing circuitry 220 may enable the DMA controller 132 to operate in a mode corresponding to a stored value by storing the value in a register having a name of the MODE. The register having the name of the MODE may be referred to as a mode register. In the mode register, a mode of the DMA controller 132 corresponding to computation indicated by a control signal (or a command) of the data processing circuitry 220 may be stored.

Referring to Table 1, a register having a name of the SOURCE_ADDR may be referred to as a source address register for storing an address of data to be loaded to the DMA controller 132. A register having a name of the DEST_ADDR may be referred to as a destination address register for storing an address at which data loaded to the DMA controller 132 will be stored by the DMA controller 132 in a first mode. A register having a name of the DATA_SIZE may be referred to as a data size register for storing a size of the data to be loaded to the DMA controller 132. A register having a name of the WIDTH may be referred to as a width register for storing a width of at least a portion of a matrix to be stored in the computation buffer 250. A register having a name of the HEIGHT may be referred to as a height register for storing a height of at least a portion of a matrix to be stored in the computation buffer 250. The width register and/or the height register may be referred to as a size register for storing a size of at least a portion of a matrix to be stored in the computation buffer 250. For example, the size register may include the width register and the height register. The register having the name of the DEST_OUT_ADDR may be referred to as a start address register for storing a start address of memory to transmit a result computed by the computation circuitry 270.

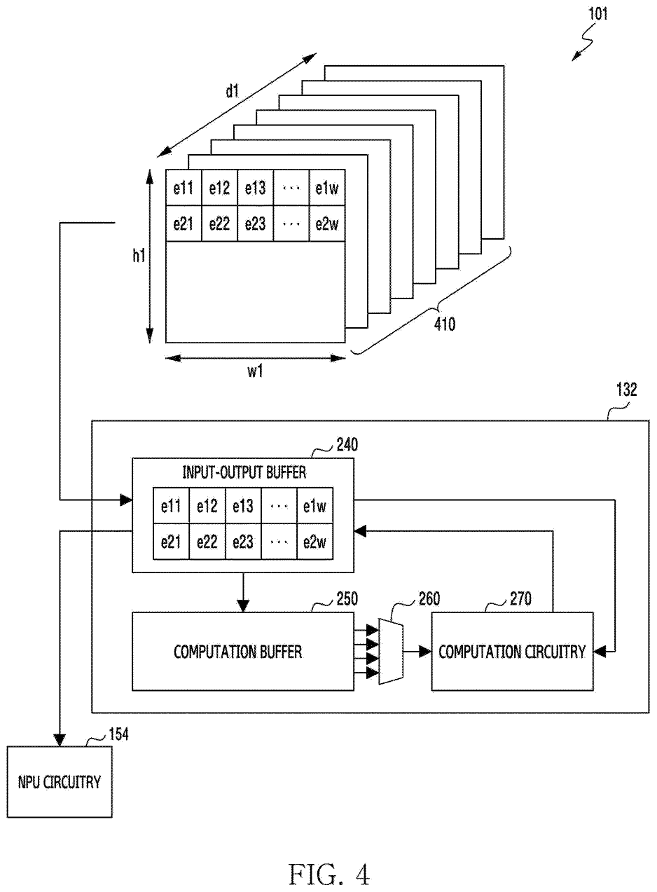

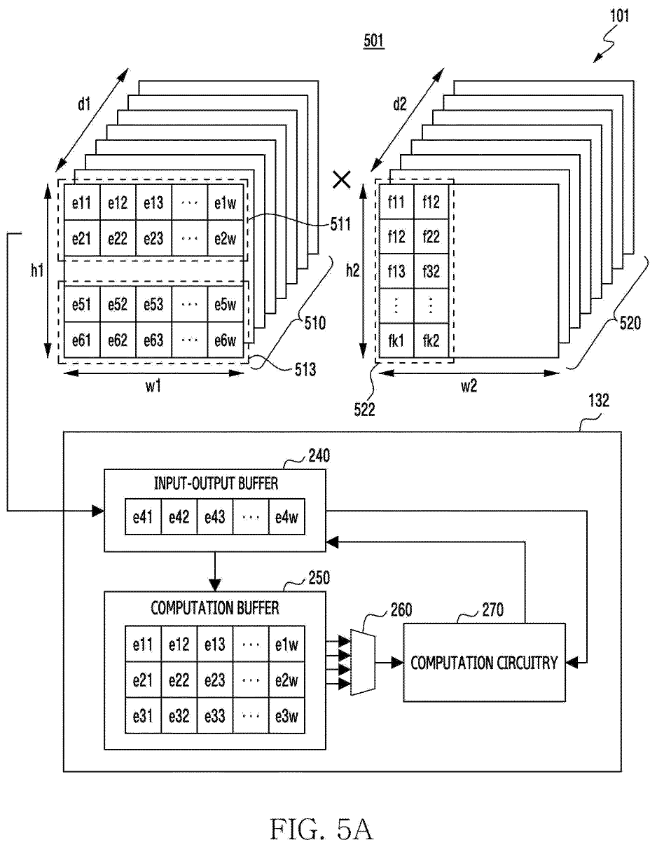

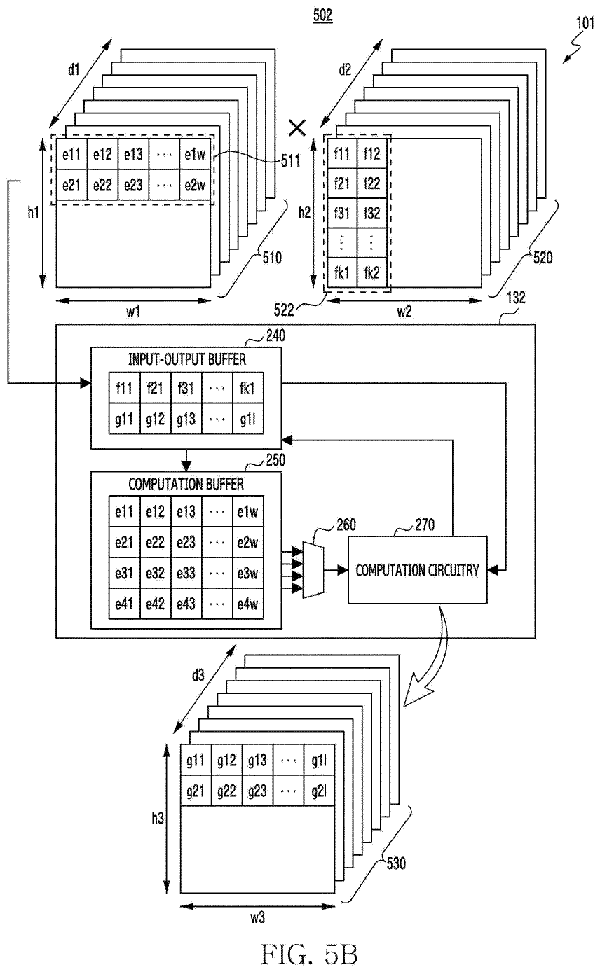

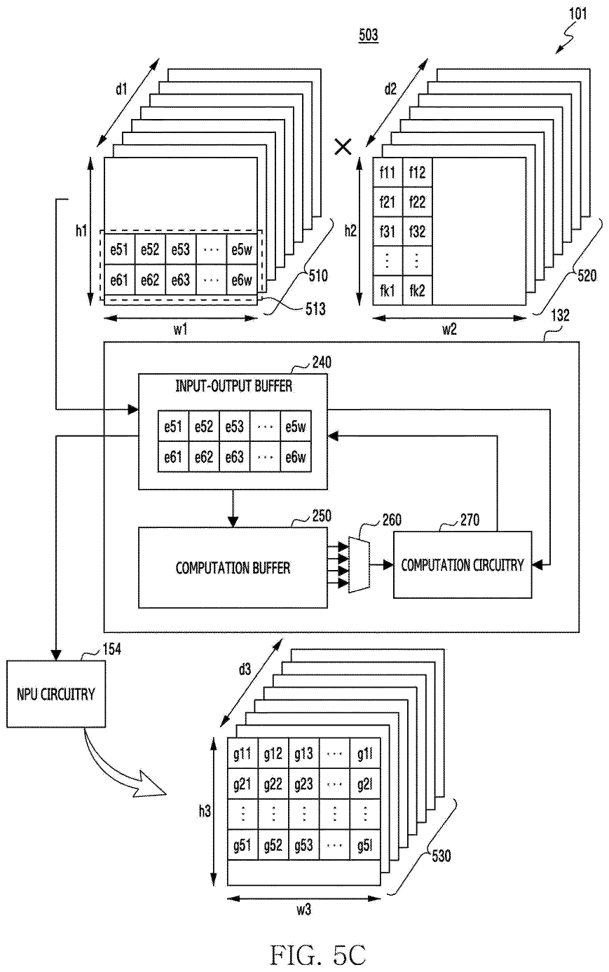

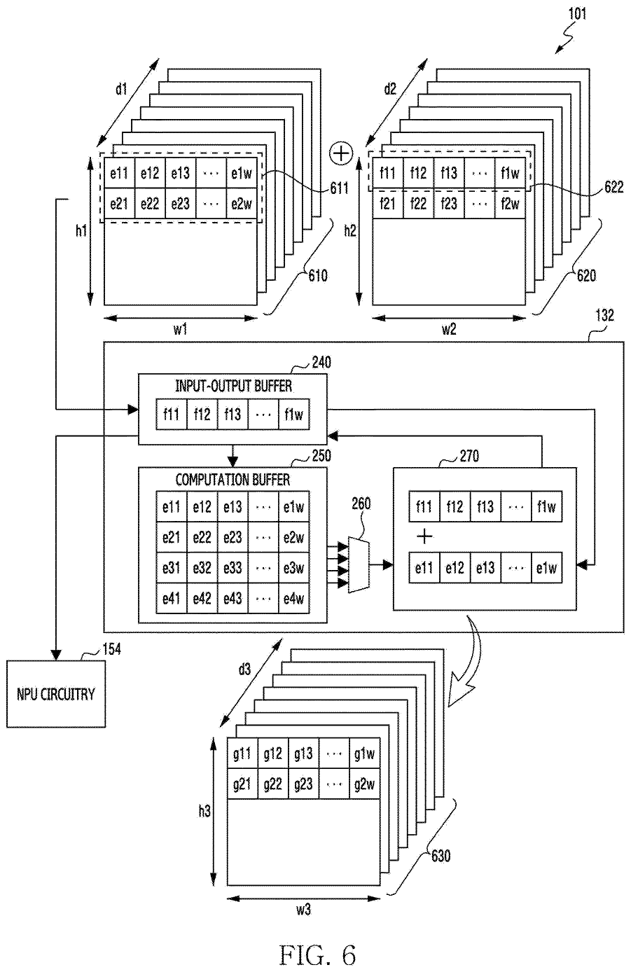

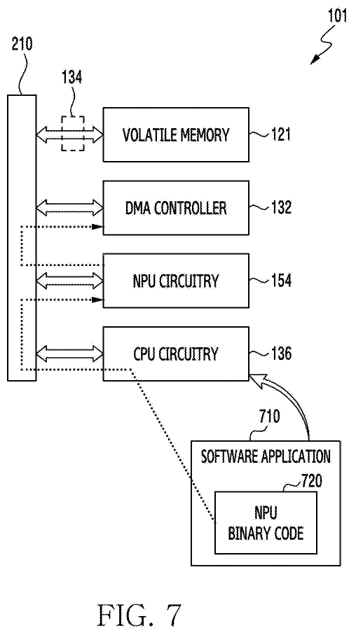

In an embodiment of the disclosure, a mode of the DMA controller 132 may include the first mode that performs transmission of data without the computation circuitry 270. An exemplary operation of the DMA controller 132 in the first mode is described with reference to FIG. 4. The mode of the DMA controller 132 may include a second mode that performs multiplication (e.g., matrix multiplication and/or dot product of vectors) of matrices using the computation circuitry 270. An exemplary operation of the DMA controller 132 in the second mode is described with reference to FIGS. 5A to 5C. The mode of the DMA controller 132 may include a third mode that performs element-wise computation (e.g., element-wise addition, element-wise subtraction, and/or element-wise multiplication) of a matrix using the computation circuitry 270. An exemplary operation of the DMA controller 132 in the third mode is described with reference to FIG. 6. Any one of preset numeric values uniquely assigned to each of the first mode to the third mode may be stored in a mode register. In response to the numeric value stored in the mode register, the DMA controller 132 may switch to a mode corresponding to the preset numeric value. An operation of the data processing circuitry 220 for generating a control signal for setting the plurality of registers of the DMA controller 132 is described with reference to FIG. 7.

Hereinafter, an exemplary operation of the DMA controller 132 including the hardware configuration of FIG. 2 is described with reference to FIG. 3.

FIG. 3 illustrates an exemplary flowchart of a DMA controller included in an electronic device according to an embodiment of the disclosure.

The electronic device 101 and/or the DMA controller 132 of FIGS. 1A, 1B, and 2 may perform an operation described with reference to FIG. 3.

Referring to FIG. 3, in operation 310, the DMA controller of the electronic device according to an embodiment may receive a command associated with computation of first data and second data from data processing circuitry. The data processing circuitry of the operation 310 may include the data processing circuitry 220 of FIG. 2. The command of the operation 310 may include a value to be stored in at least one of the registers of the DMA controller described with reference to Table 1. For example, information associated with the command of the operation 310 may be stored in the registers of the DMA controller. Based on the registers of the DMA controller, which are adjusted based on the command of the operation 310, the DMA controller may determine or identify computation indicated by the command. In an embodiment of the disclosure, the command may be provided from the data processing circuitry (e.g., the NPU circuitry 154 of FIGS. 1A and/or 1B) to perform computation associated with a neural network.

Referring to FIG. 3, in operation 320, the DMA controller of the electronic device according to an embodiment may determine whether a command for activating computation circuitry of the DMA controller is received. For example, the DMA controller may determine whether it has received a command associated with computation circuitry (e.g., the computation circuitry 270 of FIG. 2) of the DMA controller using a value stored in the mode register (e.g., the register having the name of the MODE) described with reference to Table 1. In a case of receiving the command associated with the computation circuitry, the DMA controller may activate the computation circuitry. When receiving the command for activating the computation circuitry (320—Yes), the DMA controller may perform operation 340. When receiving a command indicating an operation of the DMA controller independent of the computation circuitry (320—No), the DMA controller may perform operation 330. For example, the DMA controller that supports the first mode, the second mode, and the third mode described with reference to FIG. 2 may perform the operation 330 in a case that a numeric value indicating the first mode is identified from the mode register. In the example, the DMA controller that has identified a numeric value indicating the second mode and/or the third mode from the mode register may perform the operation 340.

Referring to FIG. 3, in the operation 330, the DMA controller of the electronic device according to an embodiment may transmit the first data and the second data to the data processing circuitry. Without modification of the first data and the second data, the DMA controller may transmit all of the first data and the second data to the data processing circuitry that has transmitted the command of the operation 310. While transmitting the first data and the second data, the first data and/or the second data may be at least temporarily stored in an input-output buffer (e.g., the input-output buffer 240 of FIG. 2) of the DMA controller.

Referring to FIG. 3, in the operation 340, the DMA controller of the electronic device according to an embodiment may perform computation with respect to a first portion of the first data and a second portion of the second data preset by the command, using the computation circuitry of the DMA controller. In order to use a computation resource of the DMA controller, the data processing circuitry may transmit the command indicating the computation of the first data and the second data by the DMA controller to the DMA controller. The computation may include matrix computation (e.g., matrix multiplication, element-wise addition, and/or element-wise multiplication) performed corresponding to the first data and the second data, which are matrices. A matrix including a plurality of elements arranged along one or more rows and/or one or more columns may be referred to as a vector (or a vector matrix) in a case that any one of the row or the column is 1. The computation supported by the DMA controller may include computation (e.g., dot product (or scalar product or inner product) and/or cross product (or tensor product or outer product)) between different vectors.

Referring to FIG. 3, in operation 350, the DMA controller of the electronic device according to an embodiment may transmit a remaining portion of the first data and a remaining portion of the second data to the data processing circuitry. Although an embodiment of the DMA controller performing the operation 350 after the operation 340 has been described, an order in which the DMA controller performs the operations 340 and 350 may vary according to an embodiment. For example, the DMA controller may perform the operations 340 and 350 substantially simultaneously. For example, the DMA controller may perform the operation 340 after performing the operation 350. The data processing circuitry that has received the remaining portions of the operation 350 may perform computation with respect to the remaining portion of the first data and the remaining portion of the second data.

In an embodiment of the disclosure, a bus interface (e.g., the bus interface 210 of FIG. 2) may be used to transmit the remaining portions of the operation 350. In a case that the DMA controller and the data processing circuitry are disposed on different dies, one or more TSVs (e.g., the plurality of TSVs 142 of FIGS. 1A and/or 1B) connecting the dies may be used. In an embodiment in which the DMA controller performs computation with respect to the first portion and the second portion, since the one or more TSVs transmit only the remaining portions, power consumption of the bus interface may be reduced.

Referring to FIG. 3, in operation 360, the DMA controller of the electronic device according to an embodiment may output a computation result for the first portion and the second portion to circuitry preset by the command. The preset circuitry of the operation 360 may be mapped to an address stored in the register (e.g., the start address register) having the name of the DEST_OUT_ADDR of Table 1. For example, in the start address register, an address in which the computation result of the first portion and the second portion of the operation 340 is to be stored may be stored. In an embodiment in which the DMA controller performs computation of the first data and the second data, which are matrices, the computation result of the operation 360 may have a form of a matrix. The DMA controller may transmit the computation result having the form of the matrix to circuitry corresponding to an address set by the command of the operation 310. Although an embodiment of the DMA controller performing the operation 360 after the operation 350 has been described, the embodiment is not limited thereto. For example, after performing the operation 340, the DMA controller may perform the operation 360 independently of the operation 350.

Hereinafter, an exemplary operation of the DMA controller assisting computation of NPU circuitry by being controlled by the NPU circuitry (e.g., the NPU circuitry 154 of FIGS. 1A and/or 1B) is described. An embodiment is not limited thereto, and the DMA controller may assist computation of CPU circuitry (e.g., the CPU circuitry 136 of FIGS. 1A and 1B) and/or GPU circuitry.

In an embodiment of the disclosure, in order to simulate a neural network, the NPU circuitry may perform computation with respect to n-dimensional (n>1) matrices. The computation with respect to the matrices may include convolution, dot product, matrix multiplication, and/or element-wise computation. As dimensions (e.g., a dimension, a width, a height, and/or a depth) of the matrix associated with the computation of the NPU circuitry increase, a size of data for transmitting the matrix to the NPU circuitry or outputted from the NPU circuitry may increase. For example, a size of data transmitted by the DMA controller may increase. In an embodiment of at least partially performing computation of data processing circuitry, such as the NPU circuitry, the DMA controller may at least partially perform the computation of the NPU circuitry based on the operation of FIG. 3. The DMA controller that at least partially performs the computation of the NPU circuitry may reduce the power and/or time consumed to transmit a matrix to the NPU circuitry and improve performance of a neural network.

For example, based on the operation 340 of FIG. 3, the DMA controller may perform a first computation with respect to the first data of the first data and the second data used in the neural network. A result of the first computation may be transmitted to the NPU circuitry and/or memory (e.g., the volatile memory 121 of FIGS. 1A and 1B) for driving the neural network. For the first computation, the first data and third data used for the first computation may be stored in each of different buffers (e.g., an input-output buffer and/or a computation buffer) of the DMA controller. The computation circuitry of the DMA controller may perform the first computation with respect to the first data and the third data. The NPU circuitry may perform a second computation with respect to the result of the first computation or the second data. The NPU circuitry may transmit a result of the second computation to the memory. The second computation may include computation associated with the neural network, such as convolution.

Hereinafter, an exemplary operation of the electronic device and/or the DMA controller associated with the operation 330 of FIG. 3 is described with reference to FIG. 4.

FIG. 4 illustrates an operation of a DMA controller 132 that transmits data, such as a matrix 410 according to an embodiment of the disclosure.

The electronic device 101 and/or the DMA controller 132 of FIGS. 1A, 1B, and 2 may perform an operation of an electronic device 101 and/or the DMA controller 132 of FIG. 4. The operation of the DMA controller 132 described with reference to FIG. 4 may be associated with at least one of the operations of FIG. 3 (e.g., the operation 330 of FIG. 3).

Referring to FIG. 4, a three-dimensional matrix 410 is exemplarily illustrated as an example of data used by data processing circuitry (e.g., the data processing circuitry 220 of FIG. 2), such as NPU circuitry 154. Although the matrix 410 with an exemplary width w1, height h1, and depth d1 is illustrated, dimensions of the matrix 410 are not limited to the example. The NPU circuitry 154 may set a mode of the DMA controller 132 to a first mode for loading data (e.g., the matrix 410) to the NPU circuitry 154, using a control signal for storing data and/or values in registers (e.g., the registers exemplified in Table 1) of the DMA controller 132.

For example, by a control signal (or a command) received from the NPU circuitry 154, a start address of an area of circuitry (e.g., the cache memory 134 and/or the volatile memory 121 of FIGS. 1A and/or 1B) in which the matrix 410 is stored may be stored in a source register of the DMA controller 132. By the control signal, a preset numeric value indicating the first mode may be stored in a mode register of the DMA controller 132. By the control signal, an address indicating a destination of the matrix 410 to be transmitted by the DMA controller 132 may be stored in a destination address register of the DMA controller 132. For example, in a case that the NPU circuitry 154 loads the matrix 410, a start address of an area of memory (or a DMA controller included in the NPU circuitry 154) included in the NPU circuitry 154 may be stored in the destination address register. By the control signal, a size of the matrix 410 may be stored in a data size register of the DMA controller 132. For example, in a case that elements of the matrix 410 have a size of 1 byte, a numeric value corresponding to w1×h1×d1 may be stored in the data size register.

In an embodiment of the disclosure, in a case that configuration of a plurality of registers by the control signal transmitted from the NPU circuitry 154 is completed, the DMA controller 132 may perform an operation associated with data stored in the plurality of registers. For example, the DMA controller 132 may obtain at least a portion of the matrix 410 by accessing memory (e.g., the cache memory 134 and/or the volatile memory 121 of FIGS. 1A and 1B) of the electronic device 101 using the address stored in the source register. The DMA controller 132 may identify the matrix 410, specified by the size stored in the data size register, from the address stored in the source register. For example, in the memory, the DMA controller 132 may load data having the size stored in the data size register, from the address in the memory stored in the source register. The loaded data may be identified as the matrix 410. The DMA controller 132 may at least partially copy the matrix 410 to an input-output buffer 240 based on a size of the input-output buffer 240.

Referring to FIG. 4, a computation buffer 250, a computation switch 260, and/or computation circuitry 270 of the DMA controller 132 may be deactivated in an exemplary state operating based on the first mode. The DMA controller 132 may transmit at least a portion of the matrix 410 stored in the input-output buffer 240 to the address stored in the destination address register. By a control signal of the NPU circuitry 154, the DMA controller 132 may transmit at least a portion of the matrix 410 stored in the input-output buffer 240 to the NPU circuitry 154 in an exemplary state in which an address corresponding to the NPU circuitry 154 is stored in the destination address register.

Hereinafter, an exemplary operation of the DMA controller associated with the operations 340, 350, and 360 of FIG. 3 is described with reference to FIGS. 5A, 5B, and/or 5C.

FIGS. 5A, 5B, and 5C illustrate exemplary operations of a DMA controller 132 that performs computation of matrices (e.g., a first matrix 510 and/or a second matrix 520) according to various embodiments of the disclosure.

The electronic device 101 and/or the DMA controller 132 of FIGS. 1A, 1B, and 2 may perform an operation of an electronic device 101 and/or the DMA controller 132 of FIGS. 5A to 5C. The operation of the DMA controller 132 described with reference to FIGS. 5A to 5C may be associated with at least one of the operations of FIG. 3 (e.g., the operations 340, 350, and/or 360 of FIG. 3).

Referring to FIGS. 5A to 5C, exemplary states 501, 502, and 503 of the DMA controller 132 performing multiplication computation of matrices (e.g., the first matrix 510 and the second matrix 520) in a second mode are illustrated. Although the three-dimensional first matrix 510 with an exemplary width w1, height h1, and depth d1 and the three-dimensional second matrix 520 with an exemplary width w2, height h2, and depth d2 are exemplarily illustrated, a size of a matrix that may be computed by the DMA controller 132 is not limited to the first matrix 510 and/or the second matrix 520.

In an embodiment of the disclosure, the NPU circuitry 154 may obtain the first matrix 510 and the second matrix 520 from memory (e.g., the cache memory 134, the volatile memory 121, and/or the non-volatile memory 122 of FIGS. 1A and/or 1B) to perform computation of the first matrix 510 and the second matrix 520. In order to obtain the first matrix 510 and the second matrix 520, the NPU circuitry 154 may transmit a command associated with the computation of the first matrix 510 and the second matrix 520 to the DMA controller 132. For example, elements of the first matrix 510 and the second matrix 520 may be referred to as first data and/or second data used in an artificial intelligence model executed by the NPU circuitry 154.

In an embodiment of the disclosure, the command transmitted to the DMA controller 132 may include data and/or at least one value to be stored in a plurality of registers (e.g., the registers exemplified in Table 1) of the DMA controller 132. The command may include information indicating a first portion 511 of the first matrix 510 and a second portion 522 of the second matrix 520 associated with computation to be performed by the DMA controller 132. The DMA controller 132 that has identified the command may perform caching of the first matrix 510 and/or the second matrix 520. Based on the caching, the first matrix 510 and the second matrix 520 stored in volatile memory may be stored in cache memory.

Referring to FIG. 5A, the exemplary state 501 of the DMA controller 132 loading the first matrix 510 stored in memory, such as the cache memory is illustrated. In the state 501, the DMA controller 132 may store the first portion 511 of the first matrix 510 in a computation buffer 250 of the DMA controller 132. The first portion 511 may be distinguished from a remaining portion 513 (e.g., a portion including e51 to e6w as an element) of the first matrix 510 by the size register of Table 1. The first portion 511 may be moved to the computation buffer 250 through an input-output buffer 240.

Referring to FIG. 5A, elements of the first matrix 510 (e.g., e11 to e3w included in three rows of the first matrix 510) may be stored in the computation buffer 250. In the state 501 of FIG. 5A, elements (e.g., e41 to e4w) of a specific row of the first matrix 510 stored in the input-output buffer 240 may be moved to the computation buffer 250. After the elements (e.g., the e41 to e4w) of the specific row of the first matrix 510 are moved to the computation buffer 250, elements (e.g., e11 to e4w) included in four rows of the first matrix 510 may be stored in the computation buffer 250. The elements stored in the computation buffer 250 may be elements included in the first portion 511 of the first matrix indicated by the command provided by the NPU circuitry 154.

Referring to FIG. 5A, a matrix to be stored in the computation buffer 250 among the first matrix 510 or the second matrix 520 may be selected or determined by data processing circuitry, such as the NPU circuitry 154 that provides the command. For example, the NPU circuitry 154 may select or determine a matrix to be stored in the computation buffer 250 among the first matrix 510 or the second matrix 520 using a size of the computation buffer 250 and/or the input-output buffer 240.

After the first portion 511 of the first matrix is stored in the computation buffer 250 in the state 501 of FIG. 5A, the DMA controller 132 may switch to the state 502 of FIG. 5B. In the state 502, the DMA controller 132 may store at least a portion of the second portion 522 of the second matrix indicated by the command provided by the NPU circuitry 154 in the input-output buffer 240. In the second mode of performing matrix multiplication, in order to perform the matrix multiplication, the DMA controller 132 may obtain the first portion 511 of the first matrix 510 specified along a row direction and the second portion 522 of the second matrix 520 specified along a column direction. In the exemplary state 502 of FIG. 5B, a plurality of rows (e.g., four rows) included in the first portion 511 of the first matrix 510 may be stored in the computation buffer 250, and at least one column (e.g., one column including k elements of f11 to fk1) included in the second portion 522 of the second matrix 520 may be stored in the input-output buffer 240. For example, the elements f11 to fk1 in a specific column of the second matrix 520 may be stored in the input-output buffer 240. In an embodiment of the disclosure, the size of the input-output buffer 240 and/or the computation buffer 250 is not limited to exemplary sizes (e.g., a size of the computation buffer 250 of 4×w) of FIGS. 5A to 5C.

Referring to FIG. 5B, the DMA controller 132 may perform computation with respect to the first portion 511 and the second portion 522 in the state 502 in which the first portion 511 of the first matrix 510 is stored in the computation buffer 250 and the second portion 522 of the second matrix 520 is stored in the input-output buffer 240. By using the computation switch 260, the DMA controller 132 may sequentially input the plurality of rows stored in the computation buffer 250 to computation circuitry 270. By controlling the computation circuitry 270, the DMA controller 132 may perform matrix multiplication with respect to a specific row of the first matrix 510 inputted to the computation circuitry 270 through the computation switch 260 and a specific column of the second matrix 520 stored in the input-output buffer 240. For example, from the computation circuitry 270 to which a specific row (a row with elements of e11, e12, . . . , e1w) of the first matrix 510 and a specific column (f11, f21, . . . , fk1) of the second matrix 520 stored in the input-output buffer 240 are inputted, the DMA controller 132 may obtain multiplication (e.g., g11=e11×f11+e12×f21+ . . . +e1w×fk1) of the specific row and the specific column. A result g11 of the multiplication may be stored in the input-output buffer 240.

Referring to FIG. 5B, the DMA controller 132 that performs matrix multiplication using the computation circuitry 270 may obtain or generate at least a portion of a third matrix 530 corresponding to the matrix multiplication of the first matrix 510 and the second matrix 520. The three-dimensional third matrix 530 with an exemplary width w3, height h3, and depth d3 are exemplarily illustrated. In the exemplary state 502 of FIG. 5B, the DMA controller 132 may obtain multiplication results of each of a plurality of rows of the first matrix 510 with respect to a column of the second matrix 520.

In an embodiment of the disclosure, the DMA controller 132 may transmit the result (e.g., the at least a portion of the third matrix 530) of performing the computation with respect to the first portion 511 of the first matrix 510 and the second portion 522 of the second matrix 520 to circuitry corresponding to a destination address (e.g., an address stored in a start address register) set by the command of the NPU circuitry 154. The circuitry corresponding to the destination address may include any one of volatile memory, cache memory, and/or NPU circuitry. An embodiment is not limited thereto, and the circuitry corresponding to the destination address may be circuitry including specific memory cell mapped by an address map among the circuitry of the electronic device 101. For example, the DMA controller 132 may transmit the at least a portion of the third matrix 530 to the cache memory among the NPU circuitry 154 or the cache memory. In a case that the NPU circuitry 154 and the cache memory are disposed on different dies of a processor 110, the DMA controller 132 may transmit the at least a portion of the third matrix 530 to the cache memory disposed on a first die (e.g., the first die 130 of FIGS. 1A and/or 1B) on which the DMA controller 132 is disposed, or to the NPU circuitry 154 disposed on a second die (e.g., the second die 150 of FIGS. 1A and/or 1B) different from the first die. For example, the result of performing the computation with respect to the first portion 511 of the first matrix 510 and the second portion 522 of the second matrix 520 may be transmitted to the cache memory disposed on the first die. Before being transmitted to the cache memory, the at least a portion of the third matrix 530 may be at least temporarily stored in the input-output buffer 240 (g11 to g11 stored in the input-output buffer in the exemplary state of FIG. 5B). The states 501 and 502 of FIGS. 5A and/or 5B may be a state of the DMA controller 132 while performing the operation 340 of FIG. 3.

Referring to FIG. 5C, the exemplary state 503 of the DMA controller 132 that has obtained the remaining portion 513 different from the first portion 511 of the first matrix 510 set by the command of the NPU circuitry 154 is illustrated. The remaining portion 513 may correspond to another portion of the first matrix 510 except for the first portion 511 set by the command of the NPU circuitry 154. The remaining portion 513 may correspond to at least a portion of the matrix 510 set to be transmitted to the NPU circuitry 154 without the computation of the DMA controller 132 by the command of the NPU circuitry 154. The DMA controller 132 may transmit the remaining portion 513 to the NPU circuitry 154 in the state 503 in which the remaining portion 513 different from the first portion 511 specified by data stored in a register (e.g., a source register and/or a size register) of the DMA controller 132 is stored in the input-output buffer 240. Similarly, the DMA controller 132 may transmit a remaining portion of the second matrix 520 different from the second portion 522 of the second matrix 520 to the NPU circuitry 154. The remaining portions may be transmitted to the NPU circuitry 154 through a bus interface including a plurality of TSVs (e.g., the plurality of TSVs 142 of FIGS. 1A and/or 1B). In an embodiment in which the NPU circuitry 154 is disposed in the second die different from the first die of the processor 110 in which the DMA controller 132 and/or the cache memory are disposed, the remaining portions may be transmitted from the first die on which the DMA controller 132 is disposed to the second die on which the NPU circuitry 154 is disposed.

In the exemplary state 503 of FIG. 5C, the NPU circuitry 154 may perform matrix multiplication with respect to the remaining portion 513 of the first matrix 510 and the remaining portion of the second matrix 520. By the matrix multiplication performed by the NPU circuitry 154, remaining elements different from elements filled by the computation of the DMA controller 132 in the third matrix 530 may be determined or calculated. The NPU circuitry 154 may store a result of the matrix multiplication in an area of memory specified by a command provided to the DMA controller 132.

For example, a portion of the third matrix 530 computed by the DMA controller 132 and a remaining portion of the third matrix 530 computed by the NPU circuitry 154 may be stored in an area of memory including an address stored in a start address register of the DMA controller 132. In the exemplary state 503 of FIG. 5C, the DMA controller 132 may transmit the remaining portion 513 (e.g., a portion including e51 to e6w as an element) of the first matrix 510 to the NPU circuitry 154. The NPU circuitry 154 may perform matrix multiplication using the remaining portion 513 of the first matrix 510 and the remaining portion of the second matrix 520 additionally transmitted from the DMA controller 132. Based on the matrix multiplication performed by the NPU circuitry 154, elements (e.g., g51 to g51) of the third matrix 530 may be determined.

Referring to FIGS. 5A to 5C, an exemplary operation of the DMA controller 132 performing matrix multiplication of the first matrix 510 and/or the second matrix 520 larger than the size of the computation buffer 250 is described. An embodiment is not limited thereto, and the DMA controller 132 may perform matrix multiplication of the first matrix 510 and/or the second matrix 520 with a size smaller than or equal to the computation buffer 250. In an embodiment of performing the matrix multiplication of the first matrix 510 and/or the second matrix 520 with a size smaller than or equal to the computation buffer 250, the DMA controller 132 may complete the matrix multiplication without transmitting the first matrix 510 or the second matrix 520 to the NPU circuitry 154. For example, the DMA controller 132 may perform the matrix multiplication indicated by the command of the NPU circuitry 154 using the computation circuitry 270. In an embodiment in which the DMA controller 132 has completed matrix multiplication using a control signal provided from the NPU circuitry 154 without the NPU circuitry 154 (or independently of the NPU circuitry 154), data transmission (e.g., transmission of data through the plurality of TSVs) between the dies on which each of the DMA controller 132 and the NPU circuitry 154 is disposed may be reduced.

According to an embodiment of the disclosure, in a case that the NPU circuitry 154 performs computation with respect to all elements of the first matrix 510 and the second matrix 520, the TSVs between the first die on which the DMA controller 132 is disposed and the second die on which the NPU circuitry 154 is disposed may be at least temporarily occupied or used to transmit the entirety of the first matrix 510 and the second matrix 520. In an embodiment in which the DMA controller 132 performs computation associated with the first portion 511 of the first matrix 510 and the second portion 522 of the second matrix 520, since the NPU circuitry 154 performs only computation with respect to the remaining portion 513 of the first matrix 510, the TSVs between the first die and the second die may be at least temporarily occupied or used to transmit the remaining portion 513 of the first matrix 510 and the second matrix 520. For example, a time occupied by the TSVs to transmit data (e.g., the first matrix 510 and/or the second matrix 520) to the NPU circuitry 154 may decrease.

Hereinafter, an exemplary operation of the DMA controller associated with the operations 340, 350, and 360 of FIG. 3 is described with reference to FIG. 6.

FIG. 6 illustrates an operation of a DMA controller that performs element-wise computation according to an embodiment of the disclosure.

The electronic device 101 and/or the DMA controller 132 of FIGS. 1A, 1B, and 2 may perform an operation of an electronic device 101 and/or the DMA controller 132 of FIG. 6. The operation of the DMA controller 132 described with reference to FIG. 6 may be associated with at least one of the operations of FIG. 3 (e.g., the operations 340, 350, and/or 360 of FIG. 3).

Referring to FIG. 6, an exemplary state of the DMA controller 132 that performs element-wise computation of matrices (e.g., a first matrix 610 and/or a second matrix 620) in a third mode is illustrated. Although the three-dimensional first matrix 610 with an exemplary width w1, height h1, and depth d1 and the three-dimensional second matrix 620 with an exemplary width w2, height h2, and depth d2 and a three-dimensional third matrix 630 with an exemplary width w3, height h3, and depth d3 are exemplarily illustrated, a size of a matrix that may be computed by the DMA controller 132 is not limited to the first matrix 610 and/or the second matrix 620. In order to perform element-wise computation (e.g., element-wise addition, element-wise subtraction, element-wise multiplication, and/or element-wise division), the first matrix 610 and the second matrix 620 may have dimensions consistent with each other.

In an embodiment of the disclosure, in order to perform element-wise computation of the first matrix 610 and the second matrix 620, NPU circuitry 154 may transmit a control signal for the computation to the DMA controller 132. The DMA controller 132 may identify the command associated with element-wise computation of the first matrix 610 and the second matrix 620. Based on identifying the command, the DMA controller 132 may store a first portion 611 (e.g., a first portion including a plurality of rows) of the first matrix 610 in a computation buffer 250. The DMA controller 132 that has identified the command may store at least a portion of a second portion 622 (e.g., at least one row) of the second matrix 620 in an input-output buffer 240.

In an embodiment of performing element-wise computation, the first portion 611 (e.g., a portion of a first matrix 510 based on a data size from a start address of the first matrix 510) of the first matrix 510 stored in the computation buffer 250 may have a size different from that of a specific row and/or a specific column of the first matrix 510. For example, unlike matrix multiplication in which an entire row of the first matrix 510 and an entire column of a second matrix 520 are required, when only elements at a position corresponding to each other in the first matrix 510 and the second matrix 520 are loaded to the computation buffer 250, element-wise computation may be performed. In an embodiment of the disclosure, even when the entire computation buffer 250 is not used for storage of data, the DMA controller 132 may input at least a portion of data stored in the computation buffer 250 to the computation circuitry 270, or may store data (e.g., a result of performing element-wise computation) outputted from the computation circuitry 270 in the computation buffer 250.

Referring to FIG. 6, the first portion 611 of the first matrix 610 and the second portion 622 of the second matrix 620 specified by the NPU circuitry 154 may be stored in the computation buffer 250 and the input-output buffer 240 of the DMA controller 132, respectively. The DMA controller 132 may obtain a first element (e.g., e11) among a plurality of rows of the first portion 611 stored in the computation buffer 250 and a second element (e.g., f11) of at least one row stored in the input-output buffer 240, using the computation circuitry 270. The DMA controller 132 may obtain a result (g11=e11+f11) of addition by performing the addition computation of the first element and the second element.

In the exemplary state of FIG. 6, the DMA controller 132 may perform element-wise addition of a specific row (e.g., a row including e11 to e1w as an element) of the first matrix 610 and a specific row (e.g., a row including f11 to f1w as an element) of the second matrix 620. A result (e.g., g11=e11+f11) of performing the element-wise addition of the specific rows may be accumulated or stored in the input-output buffer 240. In an embodiment of the disclosure, the computation circuitry 270 including only one circuitry (e.g., an arithmetic logic unit (ALU) and/or a floating point unit (FPU)) for performing element-wise computation may obtain a result of the element-wise computation for the specific rows by sequentially performing the element-wise computation of elements included in the specific rows. Alternatively, the computation circuitry 270 including a plurality of ALUs may reduce power by activating any one of the plurality of ALUs and performing the element-wise computation. The result may be overwritten on a specific element (e.g., f11 stored in the input-output buffer 240 while calculating g11=e11+f11) of the input-output buffer 240 inputted to the computation circuitry 270 to perform element-wise addition. An embodiment is not limited thereto, and the result may be stored in an area of the input-output buffer 240 distinguished from the specific row.

In an embodiment of the disclosure, the DMA controller 132 may transmit the result stored in the input-output buffer 240 to circuitry corresponding to an address stored in a start address register. In a case that a size of the element-wise operation result stored in the input-output buffer 240 corresponds to a size set by a command transmitted from the NPU circuitry 154, the DMA controller 132 may transmit the result. For example, in a case that an address corresponding to memory (e.g., the volatile memory 121 of FIGS. 1A and/or 1B) of the electronic device 101 is stored in a start address register, the DMA controller 132 may transmit data to the memory corresponding to the address instead of transmitting the data (e.g., a result of element-wise computation) stored in the input-output buffer 240 to the NPU circuitry 154.

As described above, the electronic device 101 according to an embodiment may include the DMA controller 132 for assisting computation of data processing circuitry, such as the NPU circuitry 154. The DMA controller 132 may be a central DMA controller capable of receiving a command from various data processing circuitry included in a processor. The DMA controller 132 may be disposed on a die (e.g., a die produced by a process that supports a minimum line width of 3 nm) that has relatively high speed and consumes low power in the processor, and may assist computation of the data processing circuitry with faster speed and low power than data processing circuitry disposed on a different die from the die.

Hereinafter, an operation of data processing circuitry, such as the NPU circuitry 154 performed to transmit a control signal to the DMA controller 132 is described with reference to FIG. 7.

FIG. 7 illustrates an operation of an electronic device 101 for controlling a DMA controller 132 based on execution of a software application 710 according to an embodiment of the disclosure.

The electronic device 101 and/or the DMA controller 132 of FIGS. 1A, 1B, and 2 may perform the operation described with reference to FIG. 7.

Referring to FIG. 7, CPU circuitry 136 may execute instructions included in a software application 710. The CPU circuitry 136 may perform computations corresponding to each of the instructions. Data associated with the computation may be moved from memory, such as a volatile memory 121 to the CPU circuitry 136 by the CPU circuitry 136 (or a DMA controller dedicated to CPU circuitry, included in the CPU circuitry 136). An embodiment is not limited thereto, and the data associated with the computations may be moved from the volatile memory 121 and/or cache memory 134 to the CPU circuitry 136 using the DMA controller 132.

In an embodiment of the disclosure, the instructions included in the software application 710 may include not only a first type of instruction readable by the CPU circuitry 136, but also a second type of instruction readable by data processing circuitry different from the CPU circuitry 136, such as NPU circuitry 154 and/or GPU circuitry. For example, in an NPU binary code 720 included in the software application 710, the second type of instructions readable by the NPU circuitry 154 may be stored. An embodiment is not limited thereto, and the NPU binary code 720 may include text of an assembly language, which may be compiled into the second type of instructions readable by the NPU circuitry 154. The CPU circuitry 136 that has detected the NPU binary code 720 may transmit or upload at least a portion of the NPU binary code 720 to the NPU circuitry 154. The NPU circuitry 154 may perform computation indicated by the NPU binary code 720 transmitted from the CPU circuitry 136.

In an embodiment of the disclosure, the NPU circuitry 154 that performs the computation indicated by the NPU binary code 720 may determine whether to perform the computation by controlling the DMA controller 132. For example, in a case of performing a data type and/or computation supported by computation circuitry (e.g., the computation circuitry 270 of FIG. 2) included in the DMA controller 132, the NPU circuitry 154 may determine to perform the computation indicated by the NPU binary code 720 by using the DMA controller 132. For example, in a case that a temperature of a processor (e.g., the processor 110 of FIG. 1A and/or the chipset 160 of FIG. 1B) including the NPU circuitry 154 is included within a preset temperature range associated with overheating (or overload), the NPU circuitry 154 may determine to perform the computation indicated by the NPU binary code 720 by using the DMA controller 132.

As described above with reference to FIGS. 5A to 5C and/or 6, the computation supported by the DMA controller 132 may include matrix multiplication (or dot product of a vector) and element-wise computation of matrices. Among different computations for simulating a neural network indicated by the NPU binary code 720, the NPU circuitry 154 that has detected the computation supported by the DMA controller 132 may perform the detected computation by controlling the DMA controller 132. The NPU circuitry 154 may store data associated with the detected computation in registers of the DMA controller 132 described above with reference to Table 1. The NPU circuitry 154 may request the DMA controller 132 to perform computation and/or an operation indicated by the data stored in the registers.

For example, the computations performed to simulate a neural network may include matrix multiplication of different layers, convolution, element-wise computation, or a combination (e.g., a layer fusion) thereof. In a case of performing the matrix multiplication, the NPU circuitry 154 may enable the DMA controller 132 to assist the matrix multiplication by adjusting a mode of the DMA controller 132 to a second mode. In a case of performing the convolution, the NPU circuitry 154 may enable the DMA controller 132 to transmit data associated with the convolution to the NPU circuitry 154 without computation by adjusting a mode of the DMA controller 132 to a first mode. In an embodiment of the disclosure, in a case of performing all of dot product and/or the convolution included in the neural network, a specific layer of the neural network associated with the dot product may be processed by the DMA controller 132 in the second mode, and another layer of the neural network associated with the convolution may be transmitted to the NPU circuitry 154 (or the CPU 136) by the DMA controller 132 in the first mode. The NPU circuitry 154 may perform the convolution associated with the other layer by using the data transmitted from the DMA controller 132.

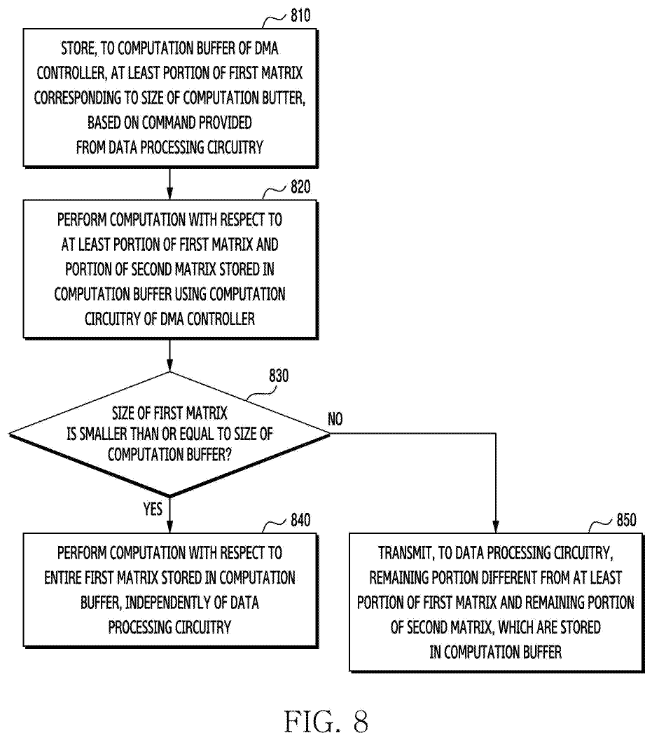

Hereinafter, an exemplary operation of the DMA controller 132 described with reference to FIGS. 1A, 1B, and 2 to 7 is described with reference to FIGS. 8 and/or 9.

FIG. 8 illustrates a flowchart of a DMA controller included in an electronic device according to an embodiment according to an embodiment of the disclosure.

The electronic device 101 and/or the DMA controller 132 of FIGS. 1A, 1B, and 2 may perform an operation described with reference to FIG. 8. The operation of the electronic device and/or the DMA controller described with reference to FIG. 8 may be associated with at least one of the operations of FIG. 3.

Referring to FIG. 8, in operation 810, the DMA controller of the electronic device according to an embodiment may store, to a computation buffer (e.g., the computation buffer 250 of FIG. 2) of the DMA controller, at least a portion of a first matrix corresponding to a size of the computation butter, based on a command provided from data processing circuitry (e.g., the data processing circuitry 220 of FIG. 2). From any one of a plurality of data processing circuitry connected to the DMA controller, the DMA controller may identify a command associated with computation of the first matrix and a second matrix by using data communication by using the DMA controller. Based on the command, through a port for data communication with memory (e.g., the volatile memory 121 of FIGS. 1A, 1B, and/or 2), the DMA controller may obtain the first matrix and the second matrix from the memory. Among the first matrix or the second matrix cached from the memory, the DMA controller may store at least a portion of the first matrix selected by the command of the operation 810 in the computation buffer. The state 501 of FIG. 5A may be associated with a state of the DMA controller performing the operation 810.

Referring to FIG. 8, in operation 820, the DMA controller of the electronic device according to an embodiment may perform computation with respect to at least a portion of the first matrix and a portion of the second matrix stored in the computation buffer using computation circuitry (e.g., the computation circuitry 270 of FIG. 2) of the DMA controller. The computation in the operation 820 may be associated with a mode of the DMA controller set by the command of the operation 810. For example, the computation of the operation 820 may be one computation selected by the mode of the DMA controller among the matrix multiplication described with reference to FIGS. 5A to 5C or the element-wise computation described with reference to FIG. 6. The state 502 of FIG. 5B may be associated with a state of the DMA controller performing the operation 820.

Referring to FIG. 8, in operation 830, the DMA controller of the electronic device according to an embodiment may identify or determine whether a size of the first matrix is smaller than or equal to a size of the computation buffer. When the size of the first matrix is smaller than or equal to the size of the computation buffer, the entire first matrix may be stored in the computation buffer based on the operation 810. When the size of the first matrix exceeds the size of the computation buffer, only a portion of the first matrix may be stored in the computation buffer based on the operation 810. When the size of the first matrix is smaller than or equal to the size of the computation buffer (830—Yes), the DMA controller may perform operation 840. When the size of the first matrix exceeds the size of the computation buffer (830—No), the DMA controller may perform operation 850.

Referring to FIG. 8, in the operation 840, the DMA controller of the electronic device according to an embodiment may perform computation with respect to the entire first matrix stored in the computation buffer, independently of the data processing circuitry. For example, the DMA controller may perform the computation of the first matrix and the second matrix indicated by the command before transmitting the first matrix and the second matrix to the data processing circuitry corresponding to the command of the operation 810, in response to obtaining the first matrix smaller than or equal to the size of the computation buffer from volatile memory and/or cache memory. For example, the transmission of the first matrix and the second matrix to the data processing circuitry that has provided the command of the operation 810 may be ceased, omitted, or bypassed.

For example, the DMA controller that has identified a command associated with the first matrix smaller than or equal to the size of the computation buffer may perform the computation of the entire first matrix and the entire second matrix using the computation circuitry of the DMA controller without transmission to NPU circuitry based on a bus interface (e.g., the bus interface 210 of FIG. 2). A result of performing the computation of the entire first matrix and the entire second matrix may be transmitted to circuitry corresponding to a destination address set by the command of the operation 810. For example, the DMA controller may transmit information and/or data including the result to circuitry (e.g., the cache memory 134, the volatile memory 121, and/or the data processing circuitry 220 of FIG. 2) corresponding to an address stored in a start address register.

Referring to FIG. 8, in the operation 850, the DMA controller of the electronic device according to an embodiment may transmit, to the data processing circuitry, a remaining portion different from the at least a portion of the first matrix and a remaining portion of the second matrix, which are stored in the computation buffer. The data processing circuitry of the operation 850 may correspond to the data processing circuitry that has provided the command of the operation 810. For example, the DMA controller that has obtained the first matrix that exceeds the size of the computation buffer from the volatile memory and/or the cache memory may perform computation with respect to a first portion of the first matrix and a second portion of the second matrix. The DMA controller may transmit a remaining portion of the first matrix different from the first portion and a remaining portion of the second matrix different from the second portion to the data processing circuitry corresponding to the command of the operation 810. The state 503 of FIG. 5C may be associated with a state of the DMA controller transmitting the remaining portions based on the operation 850.

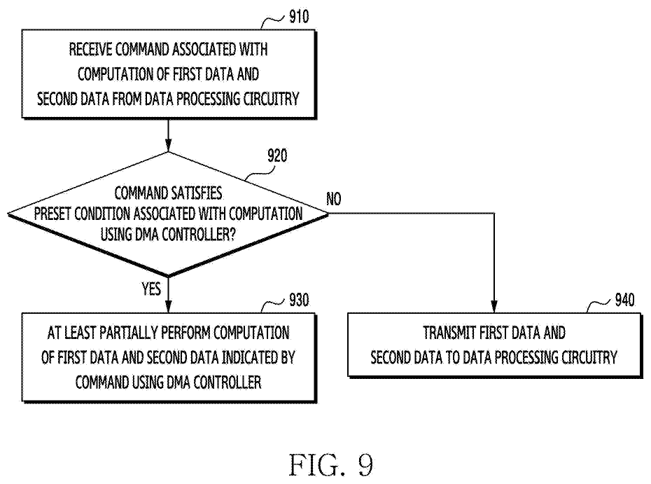

In an embodiment of the disclosure, an operation of the DMA controller determining whether to perform the entire computation of the first matrix and the second matrix based on a comparison between the size of the computation buffer and the size of the first matrix has been described, but an embodiment is not limited thereto. Hereinafter, various conditions under which the DMA controller assists computation of data processing circuitry, such as the NPU circuitry are exemplarily described with reference to FIG. 9.

FIG. 9 illustrates a flowchart of a DMA controller included in an electronic device according to an embodiment of the disclosure.

The electronic device 101 and/or the DMA controller 132 of FIGS. 1A, 1B, and 2 may perform an operation described with reference to FIG. 9. The operation of the electronic device and/or the DMA controller described with reference to FIG. 9 may be associated with at least one of the operations of FIGS. 3 and/or 8.

Referring to FIG. 9, in operation 910, the DMA controller of the electronic device according to an embodiment may receive a command associated with computation of first data and second data from data processing circuitry (e.g., the data processing circuitry 220 of FIG. 2). The first data and the second data of the operation 910 may include a matrix associated with computation of NPU circuitry. An embodiment is not limited thereto. The command of the operation 910 may include data and/or values to be stored in a plurality of registers (e.g., the registers having the names exemplified with reference to Table 1) included in the DMA controller. The DMA controller may detect the command using the registers set based on the command.

Referring to FIG. 9, in operation 920, the DMA controller of the electronic device according to an embodiment may determine whether the command received based on the operation 910 satisfies a preset condition associated with computation using the DMA controller. The preset condition of the operation 920 may be set to determine whether to assist the computation of the data processing circuitry using the DMA controller. The preset condition of the operation 920 may include at least one of exemplary conditions to be described later.

For example, the preset condition of the operation 920 may be associated with a data type of the first data and the second data. The data type may have a name, such as a floating point (fp)8 and/or an integer number (int)8. For example, the fp8 may indicate a data type for representing a floating point number using 8-bit binary numbers. For example, the int8 may indicate a data type for representing an integer using 8-bit binary numbers. Not only the above-described fp8 and int8, but also numeric values stored in the first data and/or the second data, which is a matrix, may be represented by any one of various data types, such as fp16, fp32, int2, int4, int16, and/or int32. The DMA controller may include computation circuitry (e.g., the computation circuitry 270 of FIG. 2) that supports computation of a specific data type. The preset condition of the operation 920 may include whether the data type supported by the computation circuitry of the DMA controller and the data type of the first data and the second data match each other. For example, in a case that the data type supported by the computation circuitry and the data type of the first data and the second data matches each other, the DMA controller may determine that the command of the operation 910 satisfies the preset condition of the operation 920.

For example, the preset condition of the operation 920 may be associated with the computation (or complexity of the computation) indicated by the command of the operation 920. For example, in a case of performing computation (e.g., convolution and/or softmax) different from the matrix multiplication described with reference to FIGS. 5A to 5C and/or the element-wise computation described with reference to FIG. 6, the DMA controller may determine that the preset condition of the operation 920 is not satisfied. In a case that the computation indicated by the command of the operation 910 is computation supported by the computation circuitry of the DMA controller, a controller may determine that the preset condition of the operation 920 is satisfied.

For example, the preset condition of the operation 920 may be associated with a size of the first data and the second data. In a case that the first data and/or the second data are a matrix and/or a vector, the size may include a dimension of the matrix and/or the vector. For example, the preset condition of the operation 920 may be associated with a state of the data processing circuitry. For example, in a case that the data processing circuitry operates in a preset state to reduce power consumption of the data processing circuitry, such as in a sleep state and/or in a low-power state, the DMA controller may determine that the preset condition of the operation 920 is satisfied. For example, in a case that a temperature of a processor including the data processing circuitry and/or the data processing circuitry exceeds a preset temperature threshold or included within a preset temperature range indicating overheating, the DMA controller may determine that the preset condition of the operation 920 is satisfied. The temperature may be included in the processor, or may be detected or identified by a temperature sensor adjacent to the processor.

In an embodiment of the disclosure, when the computation indicated by the command of the operation 910 satisfies the preset condition of the operation 920 (920—Yes), the DMA controller may perform operation 930. When the computation indicated by the command of the operation 910 does not satisfy the preset condition of the operation 920 (920—No), the DMA controller may perform operation 940.

Referring to FIG. 9, in the operation 940, the DMA controller of the electronic device according to an embodiment may transmit the first data and the second data to the data processing circuitry. In an embodiment of the disclosure, the DMA controller performing the operation 940 may transmit the first data and the second data to the data processing circuitry without assistance of the computation of the first data and the second data. An embodiment is not limited thereto, and the DMA controller may transmit the first data and the second data to an address indicated by the command of the operation 910. For example, in a case that the command of the operation 910 does not satisfy the preset condition of the operation 920, the DMA controller may not perform at least partially the computation indicated by the command. The DMA controller may perform the operation 940 in a first mode.

Referring to FIG. 9, in the operation 930, the DMA controller of the electronic device according to an embodiment may at least partially perform the computation of the first data and the second data indicated by the command using the DMA controller. In a case that the command of the operation 910 satisfies the preset condition of the operation 920, the DMA controller may at least partially perform the computation indicated by the command. The DMA controller may perform the operation 930 in a second mode and/or a third mode. The DMA controller may perform the computation of the first data and the second data prior to the computation by the data processing circuitry.

In an embodiment of the disclosure, the DMA controller may transmit a result of at least partially performing the computation of the first data and the second data to circuitry (e.g., the data processing circuitry and/or memory) indicated by the command of the operation 910. The DMA controller may transmit remaining portions different from at least a portion of the first data and at least a portion of the second data, which are used in the computation of the DMA controller, to the data processing circuitry that has provided the command of the operation 910. Since the remaining portions are transmitted, the data processing circuitry may complete the computation of the first data and the second data.

As described above, the DMA controller of the electronic device according to an embodiment may at least partially perform computation of various data processing circuitry connected to the DMA controller. The DMA controller may at least partially perform computation of data while transmitting and/or caching the data in response to a request of the data processing circuitry. The DMA controller may further include the computation circuitry and/or the computation buffer that may be controlled by the data processing circuitry. The data processing circuitry may determine computation to be performed (or to be assisted) by the DMA controller and/or data to be used in the computation by adjusting data and/or values stored in the registers (e.g., the registers described with reference to Table 1) of the DMA controller.

FIG. 10 is a block diagram illustrating an electronic device in a network environment according to an embodiment of the disclosure.

Referring to FIG. 10, an electronic device 1001 in a network environment 1000 may communicate with an external electronic device 1002 via a first network 1098 (e.g., a short-range wireless communication network), or at least one of an external electronic device 1004 or a server 1008 via a second network 1099 (e.g., a long-range wireless communication network). According to an embodiment of the disclosure, the electronic device 1001 may communicate with the external electronic device 1004 via the server 1008. According to an embodiment of the disclosure, the electronic device 1001 may include a processor 1020, memory 1030, an input module 1050, a sound output module 1055, a display module 1060, an audio module 1070, a sensor module 1076, an interface 1077, a connecting terminal 1078, a haptic module 1079, a camera module 1080, a power management module 1088, a battery 1089, a communication module 1090, a subscriber identification module (SIM) 1096, or an antenna module 1097. In some embodiments of the disclosure, at least one of the components (e.g., the connecting terminal 1078) may be omitted from the electronic device 1001, or one or more other components may be added in the electronic device 1001. In some embodiments of the disclosure, some of the components (e.g., the sensor module 1076, the camera module 1080, or the antenna module 1097) may be implemented as a single component (e.g., the display module 1060).

The processor 1020 may execute, for example, software (e.g., a program 1040) to control at least one other component (e.g., a hardware or software component) of the electronic device 1001 coupled with the processor 1020, and may perform various data processing or computation. According to an embodiment of the disclosure, as at least part of the data processing or computation, the processor 1020 may store a command or data received from another component (e.g., the sensor module 1076 or the communication module 1090) in volatile memory 1032, process the command or the data stored in the volatile memory 1032, and store resulting data in non-volatile memory 1034. According to an embodiment of the disclosure, the processor 1020 may include a main processor 1021 (e.g., a central processing unit (CPU) or an application processor (AP)), or an auxiliary processor 1023 (e.g., a graphics processing unit (GPU), a neural processing unit (NPU), an image signal processor (ISP), a sensor hub processor, or a communication processor (CP)) that is operable independently from, or in conjunction with, the main processor 1021. For example, when the electronic device 1001 includes the main processor 1021 and the auxiliary processor 1023, the auxiliary processor 1023 may be adapted to consume less power than the main processor 1021, or to be specific to a specified function. The auxiliary processor 1023 may be implemented as separate from, or as part of the main processor 1021.

The auxiliary processor 1023 may control at least some of functions or states related to at least one component (e.g., the display module 1060, the sensor module 1076, or the communication module 1090) among the components of the electronic device 1001, instead of the main processor 1021 while the main processor 1021 is in an inactive (e.g., a sleep) state, or together with the main processor 1021 while the main processor 1021 is in an active state (e.g., executing an application). According to an embodiment of the disclosure, the auxiliary processor 1023 (e.g., an image signal processor or a communication processor) may be implemented as part of another component (e.g., the camera module 1080 or the communication module 1090) functionally related to the auxiliary processor 1023. According to an embodiment of the disclosure, the auxiliary processor 1023 (e.g., the neural processing unit) may include a hardware structure specified for artificial intelligence model processing. An artificial intelligence model may be generated by machine learning. Such learning may be performed, e.g., by the electronic device 1001 where the artificial intelligence is performed or via a separate server (e.g., the server 1008). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1030 may store various data used by at least one component (e.g., the processor 1020 or the sensor module 1076) of the electronic device 1001. The various data may include, for example, software (e.g., the program 1040) and input data or output data for a command related thereto. The memory 1030 may include the volatile memory 1032 or the non-volatile memory 1034.

The program 1040 may be stored in the memory 1030 as software, and may include, for example, an operating system (OS) 1042, middleware 1044, or an application 1046.

The input module 1050 may receive a command or data to be used by another component (e.g., the processor 1020) of the electronic device 1001, from the outside (e.g., a user) of the electronic device 1001. The input module 1050 may include, for example, a microphone, a mouse, a keyboard, a key (e.g., a button), or a digital pen (e.g., a stylus pen).

The sound output module 1055 may output sound signals to the outside of the electronic device 1001. The sound output module 1055 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 1060 may visually provide information to the outside (e.g., a user) of the electronic device 1001. The display module 1060 may include, for example, a display, a hologram device, or a projector and control circuitry to control a corresponding one of the display, hologram device, and projector. According to an embodiment of the disclosure, the display module 1060 may include a touch sensor adapted to detect a touch, or a pressure sensor adapted to measure the intensity of force incurred by the touch.

The audio module 1070 may convert a sound into an electrical signal and vice versa. According to an embodiment of the disclosure, the audio module 1070 may obtain the sound via the input module 1050, or output the sound via the sound output module 1055 or a headphone of an external electronic device (e.g., the external electronic device 1002) directly (e.g., wiredly) or wirelessly coupled with the electronic device 1001.

The sensor module 1076 may detect an operational state (e.g., power or temperature) of the electronic device 1001 or an environmental state (e.g., a state of a user) external to the electronic device 1001, and then generate an electrical signal or data value corresponding to the detected state. According to an embodiment of the disclosure, the sensor module 1076 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1077 may support one or more specified protocols to be used for the electronic device 1001 to be coupled with the external electronic device (e.g., the external electronic device 1002) directly (e.g., wiredly) or wirelessly. According to an embodiment of the disclosure, the interface 1077 may include, for example, a high definition multimedia interface (HDMI), a universal serial bus (USB) interface, a secure digital (SD) card interface, or an audio interface.

A connecting terminal 1078 may include a connector via which the electronic device 1001 may be physically connected with the external electronic device (e.g., the external electronic device 1002). According to an embodiment of the disclosure, the connecting terminal 1078 may include, for example, an HDMI connector, a USB connector, an SD card connector, or an audio connector (e.g., a headphone connector).

The haptic module 1079 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 1079 may include, for example, a motor, a piezoelectric element, or an electric stimulator.

The camera module 1080 may capture a still image or moving images. According to an embodiment of the disclosure, the camera module 1080 may include one or more lenses, image sensors, image signal processors, or flashes.

The power management module 1088 may manage power supplied to the electronic device 1001. According to an embodiment of the disclosure, the power management module 1088 may be implemented as at least part of, for example, a power management integrated circuit (PMIC).

The battery 1089 may supply power to at least one component of the electronic device 1001. According to an embodiment of the disclosure, the battery 1089 may include, for example, a primary cell which is not rechargeable, a secondary cell which is rechargeable, or a fuel cell.

The communication module 1090 may support establishing a direct (e.g., wired) communication channel or a wireless communication channel between the electronic device 1001 and the external electronic device (e.g., the external electronic device 1002, the external electronic device 1004, or the server 1008) and performing communication via the established communication channel. The communication module 1090 may include one or more communication processors that are operable independently from the processor 1020 (e.g., the application processor (AP)) and supports a direct (e.g., wired) communication or a wireless communication. According to an embodiment of the disclosure, the communication module 1090 may include a wireless communication module 1092 (e.g., a cellular communication module, a short-range wireless communication module, or a global navigation satellite system (GNSS) communication module) or a wired communication module 1094 (e.g., a local area network (LAN) communication module or a power line communication (PLC) module). A corresponding one of these communication modules may communicate with the external electronic device via the first network 1098 (e.g., a short-range communication network, such as Bluetooth™, wireless-fidelity (Wi-Fi) direct, or infrared data association (IrDA)) or the second network 1099 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1092 may identify and authenticate the electronic device 1001 in a communication network, such as the first network 1098 or the second network 1099, using subscriber information (e.g., international mobile subscriber identity (IMSI)) stored in the subscriber identification module 1096.

The wireless communication module 1092 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1092 may support a high-frequency band (e.g., the millimeter wave (mmWave) band) to achieve, e.g., a high data transmission rate. The wireless communication module 1092 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1092 may support various requirements specified in the electronic device 1001, an external electronic device (e.g., the external electronic device 1004), or a network system (e.g., the second network 1099). According to an embodiment of the disclosure, the wireless communication module 1092 may support a peak data rate (e.g., 20 Gbps or more) for implementing eMBB, loss coverage (e.g., 1064 dB or less) for implementing mMTC, or user plane (U-plane) latency (e.g., 0.5 ms or less for each of downlink (DL) and uplink (UL), or a round trip of 10 ms or less) for implementing URLLC.

The antenna module 1097 may transmit or receive a signal or power to or from the outside (e.g., the external electronic device) of the electronic device 1001. According to an embodiment of the disclosure, the antenna module 1097 may include an antenna including a radiating element including a conductive material or a conductive pattern formed in or on a substrate (e.g., a printed circuit board (PCB)). According to an embodiment of the disclosure, the antenna module 1097 may include a plurality of antennas (e.g., array antennas). In such a case, at least one antenna appropriate for a communication scheme used in the communication network, such as the first network 1098 or the second network 1099, may be selected, for example, by the communication module 1090 (e.g., the wireless communication module 1092) from the plurality of antennas. The signal or the power may then be transmitted or received between the communication module 1090 and the external electronic device via the selected at least one antenna. According to an embodiment of the disclosure, another component (e.g., a radio frequency integrated circuit (RFIC)) other than the radiating element may be additionally formed as part of the antenna module 1097.

According to various embodiments of the disclosure, the antenna module 1097 may form a mmWave antenna module. According to an embodiment of the disclosure, the mm Wave antenna module may include a printed circuit board, an RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 1001 and the external electronic device 1004 via the server 1008 coupled with the second network 1099. Each of the external electronic devices 1002 or 1004 may be a device of a same type as, or a different type, from the electronic device 1001. According to an embodiment of the disclosure, all or some of operations to be executed at the electronic device 1001 may be executed at one or more of the external electronic devices 1002 or 1004, or the server 1008. For example, if the electronic device 1001 should perform a function or a service automatically, or in response to a request from a user or another device, the electronic device 1001, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1001. The electronic device 1001 may provide the outcome, with or without further processing of the outcome, as at least part of a reply to the request. To that end, a cloud computing, distributed computing, mobile edge computing (MEC), or client-server computing technology may be used, for example. The electronic device 1001 may provide ultra low-latency services using, e.g., distributed computing or mobile edge computing. In another embodiment of the disclosure, the external electronic device 1004 may include an Internet-of-things (IoT) device. The server 1008 may be an intelligent server using machine learning and/or a neural network. According to an embodiment of the disclosure, the external electronic device 1004 or the server 1008 may be included in the second network 1099. The electronic device 1001 may be applied to intelligent services (e.g., a smart home, a smart city, a smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 1040) including one or more instructions that are stored in a storage medium (e.g., internal memory 1036 or external memory 1038) that is readable by a machine (e.g., the electronic device 1001). For example, a processor (e.g., the processor 1020) of the machine (e.g., the electronic device 1001) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added. The electronic device 1001 of FIG. 10 may be an example of the electronic device 101 described with reference to FIGS. 1A, 1B, and 2 to 9.

In an embodiment of the disclosure, a method for performing computation of data processing circuitry, such as NPU circuitry using a DMA controller that provides data to the data processing circuitry for the computation may be required. As described above, a mobile communication device according to an embodiment may include memory, processing circuitry, and direct memory access (DMA) controller (e.g., the DMA controller 132 of FIGS. 1A, 1B, and 2) positioned outside the processing circuitry. The DMA controller may be configured to, when controlled by the processing circuitry, perform a first computation, among first data and second data, with respect to the first data. The DMA controller may be configured to transmit a result of the first computation to the processing circuitry or the memory. The processing circuitry may be configured to perform a second computation with respect to the result of the first computation or the second data. The processing circuitry may be configured to transmit a result of the second computation to the memory.

For example, the processing circuitry may include neural network processing unit (NPU) circuitry (e.g., the NPU circuitry 154 of FIGS. 1A and 1B).

For example, the first computation or the second computation may include at least one of dot product, matrix multiplication, element-wise addition, element-wise subtraction, or element-wise multiplication.

For example, a type of the first computation and a type of the second computation may be identical to each other.

For example, the first computation may include at least one of dot product, matrix multiplication, element-wise addition, element-wise subtraction, or element-wise multiplication. The second computation may include convolution.

For example, the DMA controller may be configured to, when a preset condition associated with the mobile communication device, the processing circuitry, or the DMA controller is satisfied, perform the first computation with respect to the first data prior to the processing circuitry.

For example, the preset condition may include, whether the mobile communication device is in a sleep mode or a low-power mode, or whether heat in an area adjacent to the processing circuitry or the DMA controller exceeds a preset temperature.

For example, the DMA controller may include an input-output buffer (e.g., the input-output buffer 240 of FIG. 2), a computation buffer (e.g., the computation buffer 250 of FIG. 2), and computation circuitry (e.g., the computation circuitry 270 of FIG. 2). The input-output buffer may store one of the first data received from the memory or third data that the first computation is to be performed with respect to the first data. The computation buffer may store another one of the first data or the third data. The computation circuitry may be configured to obtain the corresponding data among the first data or the third data from the input-output buffer. The computation circuitry may be configured to obtain the other corresponding data among the first data or the third data from the computation buffer. The computation circuitry may be configured to perform the first computation between the first data and the third data.

For example, the other corresponding data among the first data or the third data that is stored in the computation buffer may be determined based on a size of the computation buffer.

For example, the mobile communication device may include central processing unit (CPU) circuitry (e.g., the CPU circuitry 136 of FIGS. 1A and 1B). The CPU circuitry may be configured to determine the other corresponding data from the first data or the third data to be stored in the computation buffer based on the size of the computation buffer.

For example, the processing circuitry and the DMA controller may be included in a chipset (e.g., the chipset 160 of FIG. 1B).

For example, the chipset may include a first die, and a second die positioned on or under the first die. The processing circuitry may be disposed on the first die. The DMA controller may be disposed on the second die.

For example, the first die and the second die may be electrically connected through a plurality of through silicon vias (TSVs) (e.g., the plurality of TSVs 142 of FIGS. 1A and 1B).

For example, the memory and the DMA controller may be electrically connected through a first TSV among the plurality of TSVs. The DMA controller and the processing circuitry may be electrically connected through a second TSV among the plurality of TSVs.

For example, first semiconductor circuitry including the processing circuitry that is formed by a first line width process may be disposed on the first die. Second semiconductor circuitry including the DMA controller that is formed by a second line width process different from the first line width process may be disposed on the second die.

For example, the first line width process may be based on a wider line width compared to the second line width process.

For example, the first line width process may be a 4 nm process, and the second line width process may be a 3 nm process.

For example, the DMA controller may be configured to, by using a destination address that is associated with an address map to which the processing circuitry and memory of the mobile communication device are mapped, and is set by the processing circuitry, determine circuitry among the processing circuitry or the memory of the mobile communication device at which the result of the first computation is transmitted.

As described above, an electronic device (e.g., the electronic device 101 of FIGS. 1A and 1B and/or the electronic device 1001 of FIG. 10) according to an embodiment may include volatile memory (e.g., the volatile memory 121 of FIGS. 1A, 1B, and 2), and a processor (e.g., the processor 110 of FIG. 1A). The processor may include a first die including neural processing unit (NPU) circuitry (e.g., the NPU circuitry 154 of FIGS. 1A and 1B), a second die including cache memory (e.g., the cache memory 134 of FIGS. 1A and 1B) and direct memory access (DMA) controller (e.g., the DMA controller 132 of FIGS. 1A, 1B, and 2) for data communication between the volatile memory and the cache memory, and a bus interface (e.g., the bus interface 210 of FIG. 2) including through silicon vias (TSVs) (e.g., the plurality of TSVs 142 of FIGS. 1A and 1B) disposed between the first die and the second die. The DMA controller may be configured to, based on identifying a command associated with computation of data associated with a neural network from the NPU circuitry, store in the cache memory the data stored in the volatile memory. The DMA controller may be configured to perform the computation with respect to a portion of the data that is stored in the cache memory. The DMA controller may be configured to transmit, to perform computation of the NPU circuitry with respect to a remaining portion of the data different from the portion, the remaining portion to the NPU circuitry in the first die through the bus interface.

For example, the DMA controller may be configured to be controllable by central processing unit (CPU) circuitry (e.g., the CPU circuitry 136 of FIG. 1A) included in the first die or the second die.

For example, the DMA controller may be configured to include a first buffer for the data communication, a second buffer for storing data associated with the computation indicated by the command, and computation circuitry for performing computation of data stored in the first buffer and the second buffer.

For example, the DMA controller may be configured to, based on identifying the command associated with multiplication computation of a first matrix and a second matrix, store a plurality of rows included in a first portion of the first matrix stored in the second buffer, and store a column included in a second portion of the second matrix stored in the first buffer. The DMA controller may be configured to obtain multiplication results of each of the plurality of rows with respect to the column by using the computation circuitry.

For example, the DMA controller may be configured to, based on identifying the command associated with element-wise computation of a first matrix and a second matrix, store a plurality of rows included in the first portion of the first matrix stored in the second buffer, and store at least one row included in the second portion of the second matrix stored in the first buffer. The DMA controller may be configured to obtain a computation result of a first element among the plurality of rows stored in the second buffer and a second element of the at least one row stored in the first buffer by using the computation circuitry.

For example, the DMA controller may be configured to, based on identifying the command associated with a first matrix smaller than or equal to a size of the second buffer, perform the computation of the entire first matrix and an entire second matrix associated with the command by using the computation circuitry without transmission to the NPU circuitry based on the bus interface.

For example, the DMA controller may include a mode register for storing a mode of the DMA controller corresponding to the computation of a first matrix and a second matrix that is indicated by the command. The DMA controller may include a size register for storing a size of the first portion of the first matrix to be stored in the second buffer. The DMA controller may include a starting address register for storing an address at which a result computed from the first portion and the second portion based on the computation circuitry is stored.

For example, the size register may include a width register and/or a height register for respectively storing a width and a height of the first portion.

For example, the DMA controller may include a plurality of registers for storing information associated with the command. The plurality of registers may include a source address register for storing an address of the data to be loaded to the DMA controller. The plurality of registers may include a destination address register for storing an address at which the data is to be stored by the DMA controller. The plurality of registers may include a data size register for storing a size of the data to be loaded to the DMA controller.

For example, the DMA controller may be configured to transmit a matrix including a result of performing the computation with respect to the portion, to circuitry corresponding to a destination address set by the command among the volatile memory, the cache memory, or the NPU circuitry.

As described above, in an embodiment of the disclosure, a method of direct memory access (DMA) controller for data communication between volatile memory and cache memory in a processor is provided. The method may include, based on identifying a command associated with computation of data associated with a neural network from neural processing unit (NPU) circuitry disposed on a first die of the processor, storing, in the cache memory, the data stored in the volatile memory. The DMA controller may be disposed on a second die different from the first die. The method may include performing the computation with respect to a portion of the data that is stored in the cache memory. The method may include transmitting, to perform computation of the NPU circuitry with respect to a remaining portion of the data different from the portion, the remaining portion to the NPU circuitry in the first die through a bus interface including through silicon vias (TSVs) disposed between the first die and the second die.

For example, the DMA controller may be configured to be controllable by central processing unit (CPU) circuitry included in the first die or the second die.

For example, the performing may include, based on identifying the command associated with multiplication computation of a first matrix and a second matrix, storing a column included in a second portion of the second matrix in a first buffer of the DMA controller for the data communication, and storing a plurality of rows included in a first portion of the first matrix in a second buffer of the DMA controller. The performing may include obtaining multiplication results of each of the plurality of rows for the column by using computation circuitry of the DMA controller for performing computation with respect to data stored in the first buffer and the second buffer.

For example, the performing may include, based on identifying the command associated with element-wise computation of a first matrix and a second matrix, storing a plurality of rows included in the first portion of the first matrix stored in the second buffer, and storing at least one row included in the second portion of the second matrix stored in the first buffer. The performing may include obtaining a computation result of a first element among the plurality of rows stored in the second buffer and a second element of the at least one row stored in the first buffer by using the computation circuitry.

For example, the performing may include, based on identifying the command associated with a first matrix smaller than or equal to a size of the second buffer, performing the computation of the entire first matrix and an entire second matrix associated with the command by using the computation circuitry without transmission to the NPU circuitry based on the bus interface.

For example, the storing may include setting a plurality of registers of the DMA controller based on the command. The plurality of registers may include a source address register for storing an address of the data to be loaded to the DMA controller. The plurality of registers may include a destination address register for storing an address at which the data is to be stored by the DMA controller. The plurality of registers may include a data size register for storing a size of the data to be loaded to the DMA controller.

For example, the transmitting may include transmitting a matrix including a result of performing the computation with respect to the portion, to circuitry corresponding to a destination address set by the command among the volatile memory, the cache memory, or the NPU circuitry.

As described above, a processing chip component according to an embodiment may include a port for data communication with volatile memory, direct memory access (DMA) controller connected to the port, and a plurality of data processing circuitry configured to control the DMA controller. The DMA controller may be configured to identify a command to perform computation of a first matrix and a second matrix by using the data communication by using the DMA controller, from any one of data processing circuitry among the plurality of data processing circuitry. The DMA controller may be configured to obtain the first matrix and the second matrix from the volatile memory through the port based on the command. The DMA controller may be configured to, in response to obtaining the first matrix smaller than or equal to a size of a buffer included in the DMA controller from the volatile memory, perform the computation of the first matrix and the second matrix indicated by the command before transmitting the first matrix and the second matrix to the data processing circuitry corresponding to the command. The DMA controller may be configured to, based on obtaining the first matrix exceeding the size of the buffer from the volatile memory, perform computation with respect to a first portion of the first matrix and a second portion of the second matrix. The DMA controller may be configured to transmit a remaining portion of the first matrix different from the first portion and a remaining portion of the second matrix different from the second portion to the data processing circuitry corresponding to the command.

For example, the plurality of data processing circuitry may include neural processing unit (NPU) circuitry configured to perform computation associated with a neural network. The plurality of data processing circuitry may include graphic processing unit (GPU) circuitry configured to perform computation associated with a graphic rendering. The plurality of data processing circuitry may include central processing unit (CPU) circuitry configured to perform computation indicated by an instruction stored in the volatile memory.

For example, the processing chip component may include a first die on which the NPU circuitry transmitting the command is disposed. The processing chip component may include a second die on which the DMA controller is disposed. The processing chip component may include a bus interface including through silicon vias (TSVs) disposed between the first die and the second die.

For example, the DMA controller may include a first buffer storing data inputted to the DMA controller or outputted from the DMA controller. The DMA controller may include a second buffer configured to store the first portion of the first matrix, that corresponds to the buffer. The DMA controller may include computation circuitry connected to the first buffer and the second buffer.

As described above, in an embodiment of the disclosure, a method of a processing chip component including a port for data communication with volatile memory, direct memory access (DMA) controller connected to the port, and a plurality of data processing circuitry configured to control the DMA controller is provided. The method may include identifying a command to perform computation of a first matrix and a second matrix by using the data communication by using the DMA controller, from any one of data processing circuitry among the plurality of data processing circuitry. The method may include obtaining the first matrix and the second matrix from the volatile memory through the port based on the command. The method may include, in response to obtaining the first matrix smaller than or equal to a size of a buffer included in the DMA controller from the volatile memory, performing the computation of the first matrix and the second matrix indicated by the command before transmitting the first matrix and the second matrix to the data processing circuitry corresponding to the command. The method may include, based on obtaining the first matrix exceeding the size of the buffer from the volatile memory, performing computation with respect to a first portion of the first matrix and a second portion of the second matrix. The method may include transmitting a remaining portion of the first matrix different from the first portion and a remaining portion of the second matrix different from the second portion to the data processing circuitry corresponding to the command.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium, such as a hard disk, floppy disk, and magnetic tape, optical recording medium, such as CD-ROM and digital versatile disc (DVD), magneto-optical medium, such as floptical disk, and those configured to store program instructions, including read only memory (ROM), random access memory (RAM), flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method of any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. A mobile communication device comprising:
processing circuitry;
memory, comprising one or more storage media, storing instructions; and
at least one direct memory access (DMA) processor positioned outside the processing circuitry communicatively coupled to the processing circuitry and the memory,
wherein the at least one DMA processor is configured to:
when controlled by the processing circuitry, perform a first computation, among first data and second data, with respect to the first data, and
transmit a result of the first computation to the processing circuitry or the memory, and
wherein the processing circuitry is configured to:
perform a second computation with respect to the result of the first computation or the second data, and
transmit a result of the second computation to the memory.

2. The mobile communication device of claim 1, wherein the processing circuitry comprises neural network processing unit (NPU) circuitry.

3. The mobile communication device of claim 1, wherein the first computation or the second computation comprises at least one of dot product, matrix multiplication, element-wise addition, element-wise subtraction, or element-wise multiplication.

4. The mobile communication device of claim 3, wherein a type of the first computation and a type of the second computation are identical to each other.

5. The mobile communication device of claim 1,
wherein the first computation comprises at least one of dot product, matrix multiplication, element-wise addition, element-wise subtraction, or element-wise multiplication, and
wherein the second computation comprises convolution.

6. The mobile communication device of claim 1, wherein the at least one DMA processor is configured to:
when a preset condition associated with the mobile communication device, the processing circuitry, or the at least one DMA processor is satisfied, perform the first computation with respect to the first data prior to the processing circuitry.

7. The mobile communication device of claim 6, wherein the preset condition comprises, whether the mobile communication device is in a sleep mode or a low-power mode, or whether heat in an area adjacent to the processing circuitry or the at least one DMA processor exceeds a preset temperature.

8. The mobile communication device of claim 1,
wherein the at least one DMA processor comprises an input-output buffer, a computation buffer, and computation circuitry,
wherein the input-output buffer stores one of the first data received from the memory or third data that the first computation is to be performed with respect to the first data,
wherein the computation buffer stores another one of the first data or the third data, and
wherein the computation circuitry is configured to:
obtain corresponding data among the first data or the third data from the input-output buffer,
obtain another corresponding data among the first data or the third data from the computation buffer, and
perform the first computation between the first data and the third data.

9. The mobile communication device of claim 8, wherein the other corresponding data among the first data or the third data that is stored in the computation buffer is determined based on a size of the computation buffer.

10. The mobile communication device of claim 8, further comprising:
central processing unit (CPU) circuitry,
wherein the CPU circuitry is configured to determine another corresponding data from the first data or the third data to be stored in the computation buffer based on a size of the computation buffer.

11. The mobile communication device of claim 1, wherein the processing circuitry and the at least one DMA processor are included in a chipset.

12. The mobile communication device of claim 1,
wherein a chipset comprises a first die, and a second die positioned on or under the first die,
wherein the processing circuitry is disposed on the first die, and
wherein the at least one DMA processor is disposed on the second die.

13. The mobile communication device of claim 12, wherein the first die and the second die are electrically connected through a plurality of through silicon vias (TSVs).

14. The mobile communication device of claim 13,
wherein the memory and the at least one DMA processor are electrically connected through a first TSV among the plurality of TSVs, and
wherein the at least one DMA processor and the processing circuitry are electrically connected through a second TSV among the plurality of TSVs.

15. The mobile communication device of claim 12,
wherein first semiconductor circuitry including the processing circuitry that is formed by a first line width process is disposed on the first die, and
wherein second semiconductor circuitry including the at least one DMA processor that is formed by a second line width process different from the first line width process is disposed on the second die.

16. The mobile communication device of claim 15, wherein the first line width process is based on a wider line width compared to the second line width process.

17. The mobile communication device of claim 16, wherein the at least one DMA processor is configured to:
by using a destination address that is associated with an address map to which the processing circuitry and memory of the mobile communication device are mapped, and is set by the processing circuitry, determine circuitry among the processing circuitry or the memory of the mobile communication device where the result is transmitted.

18. An electronic device comprising:
volatile memory, comprising one or more storage media, storing instructions; and
at least one processor communicatively coupled to the volatile memory, wherein the at least one processor comprises:
a first die including neural processing unit (NPU) circuitry,
a second die including cache memory and at least one direct memory access (DMA) processor for data communication between the volatile memory and the cache memory, and
a bus interface including a plurality of through silicon vias (TSVs) disposed between the first die and the second die, and
wherein the at least one DMA processor is configured to:
based on identifying a command associated with computation of data associated with a neural network from the NPU circuitry, store within the cache memory the data stored in the volatile memory,
perform a computation with respect to a portion of the data that is stored in the cache memory, and
transmit, to perform computation of the NPU circuitry with respect to a remaining portion of the data different from the portion, the remaining portion to the NPU circuitry in the first die through the bus interface.

19. The electronic device of claim 18, wherein the at least one DMA processor is configured to be controllable by central processing unit (CPU) circuitry included in the first die or the second die.

20. The electronic device of claim 18, wherein the at least one DMA processor comprises:
a first buffer for the data communication;
a second buffer for storing data associated with the computation indicated by the command; and
computation circuitry for performing computation of data stored in the first buffer and the second buffer.
